(19) United States
(12) Patent Application Publication
(10) Pub. No.: US 2025/0240707 A1
(43) Pub. Date: Jul. 24, 2025

(54) METHOD AND APPARATUS FOR ACQUIRING SYSTEM INFORMATION OF CELL WITH NETWORK ENERGY EFFICIENCY IN MOBILE WIRELESS COMMUNICATION SYSTEM

(71) Applicants: Soenghun KIM, Gyeonggi-do (KR); BLACKPIN INC., Seoul (KR)

(72) Inventor: Soenghun KIM, Gyeonggi-do (KR)

(21) Appl. No.: 19/018,052

(22) Filed: Jan. 13, 2025

(30) Foreign Application Priority Data
Jan. 24, 2024 (KR) 1020240010887

(51) Int. Cl. H04W 48/16; H04W 24/10; H04W 74/0833

(52) U.S. Cl. CPC H04W 48/16; H04W 24/10; H04W 74/0833

(57) ABSTRACT

A method and apparatus to support system information acquisition procedure in a system with enhanced network energy efficiency. The method includes receiving in the first cell a synchronization signal physical broadcast channel block (SSB); and performing in the first cell a procedure for system information acquisition. An index value is determined based on a specific bit in the second set of bits and a specific field of the master information block. A first procedure is performed for system information acquisition in case that the frequency band of the first cell belongs to a first frequency region and the index value is equal to a first specific value. A second procedure is performed for system information acquisition in case that the frequency band of the first cell belongs to a first frequency region, the index value is within a first range and a scheduling information of a second system information indicates that the second system information is not broadcasting. The first procedure is to request a first system information. The second procedure is to request the second system information.

### CROSS-REFERENCE TO RELATED APPLICATION

This application claims priority to and the benefit of Korean Patent Application No. 10-2024-0010887, filed on Jan. 24, 2024, the disclosure of which is hereby incorporated herein by reference in its entirety.

### BACKGROUND

### Technical Field

The present disclosure relates to acquiring system information of cell with network energy efficiency in a mobile communication system.

### Related Art

To meet the increasing demand for wireless data traffic since the commercialization of 4th generation (4G) communication systems, the 5th generation (5G) system is being developed. 5G system introduced millimeter wave (mmW) frequency bands (e. g. 60 GHz bands). In order to increase the propagation distance by mitigating propagation loss in the 5G communication system, various techniques are introduced such as beamforming, massive multiple—input multiple output (MIMO), full dimensional MIMO (FD-MIMO), array antenna, analog beamforming, and large-scale antenna. In addition, base station is divided into a central unit and plurality of distribute units for better scalability. In the advancement of 5G networks, one significant focus is improving network energy efficiency.

### SUMMARY

Aspects of the present disclosure are to enhance system information acquisition procedure in a system with enhanced network energy efficiency. The method includes receiving in the first cell a synchronization signal physical broadcast channel block (SSB); and performing in the first cell a procedure for system information acquisition. An index value is determined based on a specific bit in the second set of bits and a specific field of the master information block. A first procedure is performed for system information acquisition in case that the frequency band of the first cell belongs to a first frequency region and the index value is equal to a first specific value. A second procedure is performed for system information acquisition in case that the frequency band of the first cell belongs to a first frequency region, the index value is within a first range and a scheduling information of a second system information indicates that the second system information is not broadcasting. The first procedure is to request the first system information. The second procedure is to request the second system information.

### BRIEF DESCRIPTION OF THE DRAWINGS

FIG. 1A is a diagram illustrating the architecture of an 5G system and a NG-RAN.

FIG. 1B is a diagram illustrating a wireless protocol architecture in an 5G system.

FIG. 2A illustrates the overall operation of the UE and network.

FIG. 2B illustrates RRC connection establishment procedure.

FIG. 2C illustrates RRC connection reconfiguration procedure.

FIG. 2D illustrates data transfer procedure in RRC_CONNECTED state.

FIG. 2E illustrates SS/PBCH block.

FIG. 3A illustrates the operation of the UE and network in legacy cell.

FIG. 3B illustrates the operation of the UE and network in assisting cell.

FIG. 3C illustrates the operation of the UE and network in assisted cell.

FIG. 3D illustrates SIB1 acquisition related parameters.

FIG. 4A is a diagram illustrating measurement operations of the terminal.

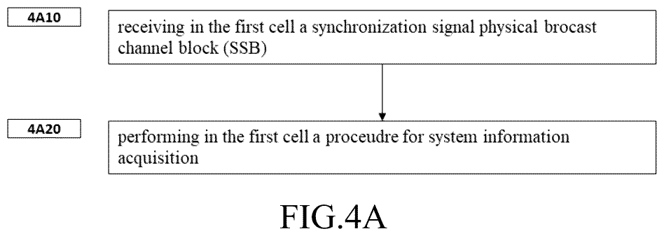

FIG. 5A is a block diagram illustrating the internal structure of a UE according to the disclosure.

FIG. 5B is a block diagram illustrating the internal structure of a base station according to the disclosure.

### DETAILED DESCRIPTION

To facilitate energy saving in network side, a feasible solution is to provide opportunities for turning off downlink transmission in base station. One example of the downlink transmission to be turned off is system information. System information is periodically transmitted to provide unspecified multiple terminals in a cell necessary information for access.

Under certain circumstances, transmission of such system information may not be necessary if access to the cell can be delayed. For example, if the geographical coverage of the cell is covered by another cell, terminal may camp on the other cell (e.g. anchor cell) first and then access to the cell (non-anchor cell) from the other cell, possibly based on assistance information achieved from the other cell.

Hereinafter, embodiments of the present disclosure will be described in detail with reference to the accompanying drawings. In addition, in the description of the present disclosure, if it is determined that a detailed description of a related known function or configuration may unnecessarily obscure the gist of the present disclosure, the detailed description thereof will be omitted. In addition, the terms to be described later are terms defined in consideration of functions in the present disclosure, which may vary according to intentions or customs of users and operators. Therefore, the definition should be made based on the content throughout this specification.

The terms used, in the following description, for indicating access nodes, network entities, messages, interfaces between network entities, and diverse identity information is provided for convenience of explanation. Accordingly, the terms used in the following description are not limited to specific meanings but may be replaced by other terms equivalent in technical meanings.

In the following descriptions, the terms and definitions given in the 3GPP standards are used for convenience of explanation. However, the present disclosure is not limited by use of these terms and definitions and other arbitrary terms and definitions may be employed instead.

In the present disclosure, “trigger” or “triggered” and “initiate” or “initiated” can be used interchangeably.

In the present disclosure, UE and terminal and wireless device can be used interchangeably. In the present disclosure, NG-RAN node and base station and GNB can be used interchangeably.

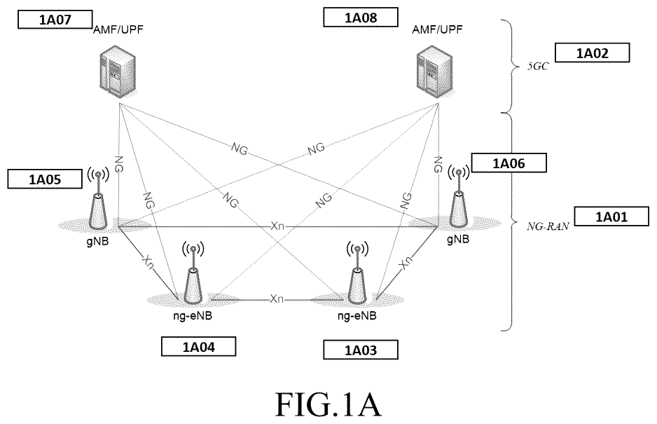

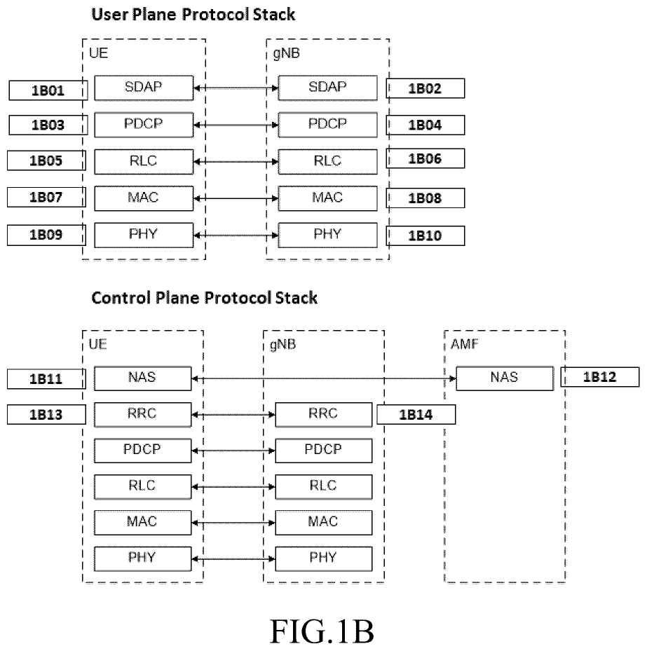

FIG. 1A is a diagram illustrating the architecture of an 5G system and a NG-RAN to which the disclosure may be applied. 5G system consists of NG-RAN 1A01 and 5GC 1A02. An NG-RAN node is either:
>1: a gNB, providing NR user plane and control plane protocol terminations towards the UE; or
>1: an ng-eNB, providing E-UTRA user plane and control plane protocol terminations towards the UE.

The gNBs 1A05 or 1A06 and ng-eNBs 1A03 or 1A04 are interconnected with each other by means of the Xn interface. The gNBs and ng-eNBs are also connected by means of the NG interfaces to the 5GC, more specifically to the AMF (Access and Mobility Management Function) and to the UPF (User Plane Function). AMF 1A07 and UPF 1A08 may be realized as a physical node or as separate physical nodes.

A gNB 1A05 or 1A06 or an ng-eNBs 1A03 or 1A04 hosts the various functions listed below.
>1: Functions for Radio Resource Management such as Radio Bearer Control, Radio Admission Control, Connection Mobility Control, Dynamic allocation of resources to UEs in uplink, downlink and sidelink (scheduling); and
>1: IP and Ethernet header compression, uplink data decompression and encryption of user data stream; and
>1: Selection of an AMF at UE attachment when no routing to an MME can be determined from the information provided by the UE; and
>1: Routing of User Plane data towards UPF; and
>1: Scheduling and transmission of paging messages; and
>1: Scheduling and transmission of broadcast information (originated from the AMF or O&M); and
>1: Measurement and measurement reporting configuration for mobility and scheduling; and
>1: Session Management; and
>1: QoS Flow management and mapping to data radio bearers; and
>1: Support of UEs in RRC_INACTIVE state; and

The AMF 1A07 hosts the functions such as NAS signaling, NAS signaling security, AS security control, SMF selection, Authentication, Mobility management and positioning management.

The UPF 1A08 hosts the functions such as packet routing and forwarding, transport level packet marking in the uplink, QoS handling and the downlink, mobility anchoring for mobility etc.

FIG. 1B is a diagram illustrating a wireless protocol architecture in an 5G system to which the disclosure may be applied.

The user plane protocol stack consists of SDAP 1B01 or 1B02, PDCP 1B03 or 1B04, RLC 1B05 or 1B06, MAC 1B07 or 1B08 and PHY 1B09 or 1B10. The control plane protocol stack consists of NAS 1B11 or 1B12, RRC 1B13 or 1B14, PDCP, RLC, MAC and PHY.

Each protocol sublayer performs functions related to the operations listed below.

NAS: authentication, mobility management, security control etc.

RRC: System Information, Paging, Establishment, maintenance and release of an RRC connection, Security functions, Establishment, configuration, maintenance and release of Signalling Radio Bearers (SRBs) and Data Radio Bearers (DRBs), Mobility, QoS management, Detection of and recovery from radio link failure, NAS message transfer etc.

SDAP: Mapping between a QoS flow and a data radio bearer, Marking QoS flow ID (QFI) in both DL and UL packets.

PDCP: Transfer of data, Header compression and decompression, Ciphering and deciphering, Integrity protection and integrity verification, Duplication, Reordering and in-order delivery, Out-of-order delivery etc.

RLC: Transfer of upper layer PDUs, Error Correction through ARQ, Segmentation and re-segmentation of RLC SDUs, Reassembly of SDU, RLC re-establishment etc.

MAC: Mapping between logical channels and transport channels, Multiplexing/demultiplexing of MAC SDUs belonging to one or different logical channels into/from transport blocks (TB) delivered to/from the physical layer on transport channels, Scheduling information reporting, Priority handling between UEs, Priority handling between logical channels of one UE etc.

PHY: Channel coding, Physical-layer hybrid-ARQ processing, Rate matching, Scrambling, Modulation, Layer mapping, Downlink Control Information, Uplink Control Information etc.

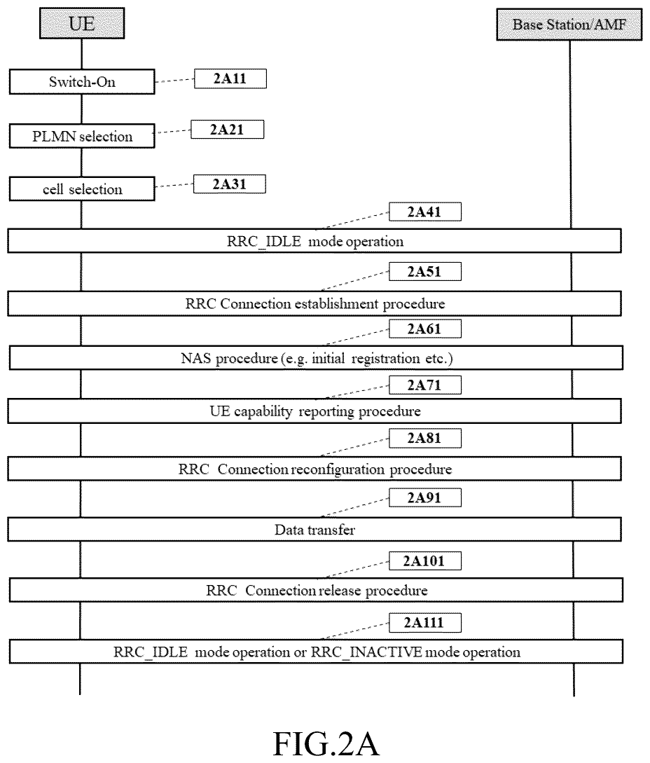

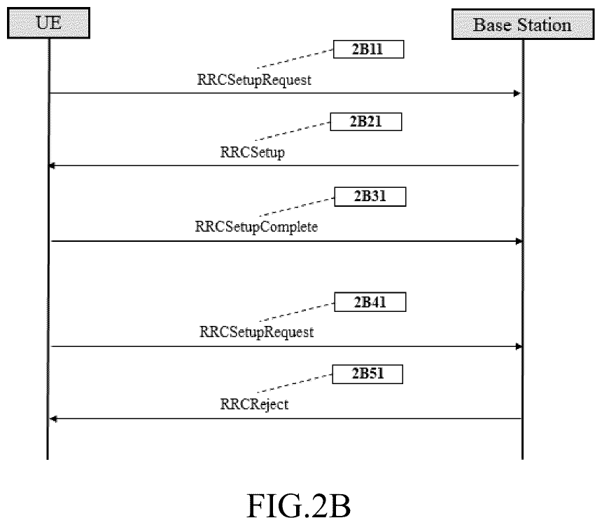

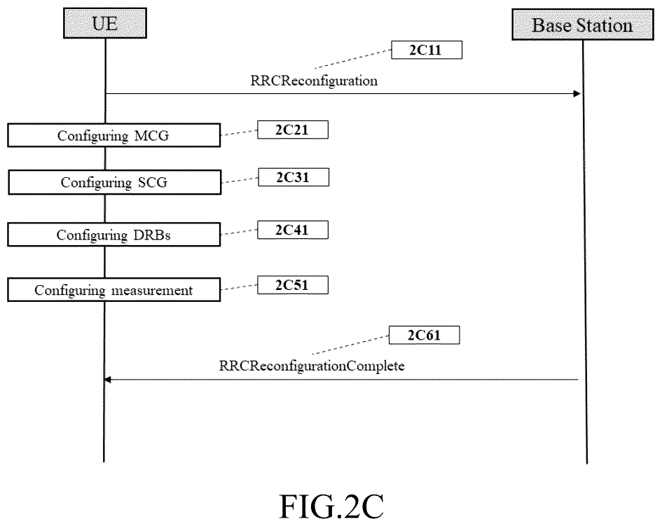

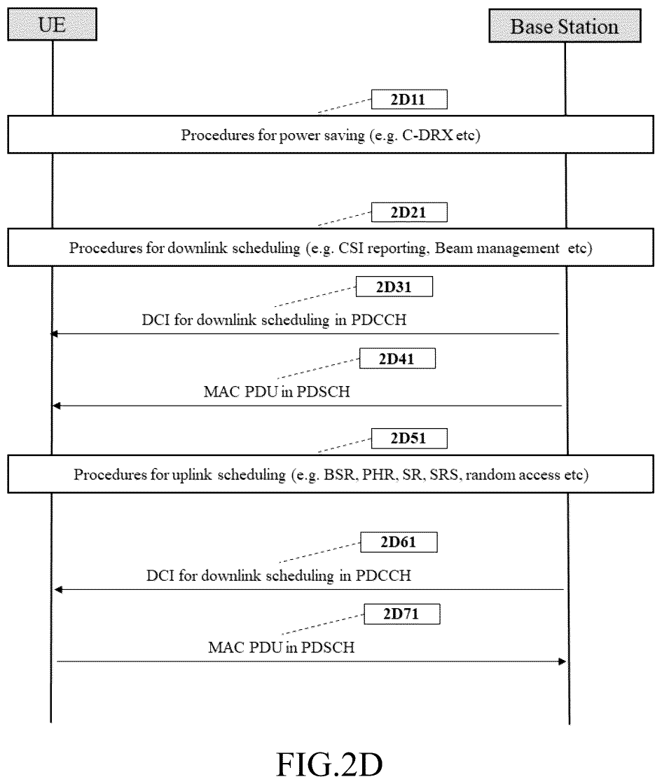

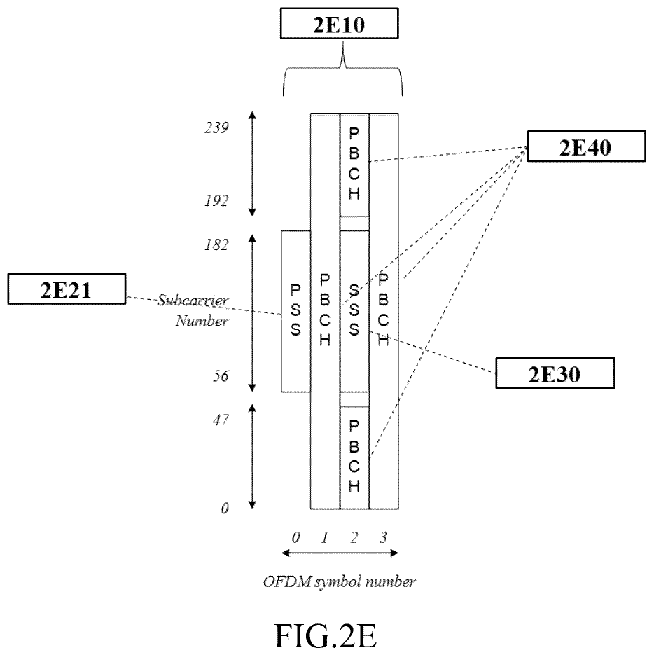

FIG. 2A illustrates overall operation of the UE and network.

Upon switch-on of the wireless device (e.g. UE) 2A11, UE performs PLMN selection 2A21 to select the carrier that is provided by the PLMN that UE is allowed to register.

Then UE performs cell selection 2A31 to camp on a suitable cell.

Once camping on a suitable cell, UE performs RRC_IDLE mode operation 2A41 such as paging channel monitoring and cell reselection and system information acquisition.

UE performs RRC Connection establishment procedure 2A51 to perform e.g. NAS procedure such as initial registration with the selected PLMN.

After successful RRC connection establishment, UE performs NAS procedure 2A61 by transmitting a corresponding NAS message via the established RRC connection (e.g. SRB1).

The base station can trigger UE capability reporting procedure 2A71 before configuring data bearers and various MAC functions.

The base station and the UE perform RRC connection reconfiguration procedure 2A81. Via the procedure, data radio bearers and logical channels and various MAC functions (such as DRX and BSR and PHR and beam failure reporting etc) and various RRC functions (such as RRM and RLM and measurement etc) are configured.

The base station and the UE perform data transfer 2A91 via the established radio bearers and based on configured MAC functions and configured RRC functions.

If geographical location of UE changes such that e.g. the current serving cell is no longer providing suitable radio condition, the base station and the UE perform cell level mobility such as handover or conditional reconfiguration or lower layer triggered mobility.

When RRC connection is no longer needed for the UE because of e.g. no more traffic available for the UE, the base station and the UE performs RRC connection release procedure 2A101. The base station can transit UE state either to RRC_IDLE (if the data activity of the UE is expected low) or to RRC_INACTIVE (if the data activity of the UE is expected high).

The UE performs either RRC_IDLE operation or RRC_INACTIVE mode operation 2A111 until the next event to RRC connection establishment/resumption occurs.

FIG. 2B illustrates RRC connection establishment procedure.

Successful RRC connection establishment procedure comprises:
>1: transmission of RRCSetupRequest by the UE 2B11;
>1: reception of RRCSetup by the UE 2B21;
>1: transmission of RRCSetupComplete by the UE 2B31.

Unsuccessful RRC connection establishment procedure comprises:
>1: transmission of RRCSetupRequest by the UE 2B41;
>1: reception of RRCReject by the UE 2B51;

RRCSetupRequest comprises following fields and IEs:
>1: ue-Identity field contains InitialUE-Identity IE which contains:
   >>2: ng-5G-S-TMSI-Part1 field containing a BIT STRING of 39 bit;
>1: establishmentCause field contains EstablishmentCause IE which contains:
   >>2 enumerated value indicating either emergency, highPriorityAccess, mt-Access, mo-Signalling, mo-Data, mo-VoiceCall, mo-VideoCall, mo-SMS, mps-PriorityAccess, mcs-PriorityAccess etc

RRCSetup comprises following fields and IEs:
>1: radioBearerConfig field containing a RadioBearerConfig IE;
>1: masterCellGroup field containing a CellGroupConfig IE.

RRCSetupComplete comprises following fields and IEs:
>1: selectedPLMN-Identity field containing an integer indicating selected PLMN;
>1: dedicatedNAS-Message field containing a DedicatedNAS-Message which may contain various NAS message;
>1: ng-5G-S-TMSI-Part2 field containing a BIT STRING of 9 bit.

RRCSetupRequest is transmitted via CCCH/SRB0, which means that the base station does not identify UE transmitting the message based on DCI that scheduling the uplink transmission. The UE includes a field (ue-Identity) in the message so that the base station identifies the UE. If 5G-S-TMSI is available (e.g. UE has already registered to a PLMN), the UE sets the field with part of the 5G-S-TMSI. If 5G-S-TMSI is not available (e.g. UE has not registered to any PLMN), the UE sets the field with 39-bit random value.

Upon reception of RRCSetup, UE configures cell group and SRB1 based on the configuration information in the RRCSetup. The UE perform following actions:
>1: perform the cell group configuration procedure in accordance with the received masterCellGroup;
>1: perform the radio bearer configuration procedure in accordance with the received radioBearerConfig;
>1: if stored, discard the cell reselection priority information provided by the cellReselectionPriorities or inherited from another RAT;
>1: enter RRC_CONNECTED;
>1: stop the cell re-selection procedure;
>1: consider the current cell to be the PCell;

The UE transmits to the base station RRCSetupComplete after performing above actions.

The UE sets the contents of RRCSetupComplete message as follows:
>1: set the ng-5G-S-TMSI-Value to ng-5G-S-TMSI-Part2;
>1: set the selectedPLMN-Identity to the PLMN selected by upper layers from the plmn-IdentityInfoList;
>1: include the s-NSSAI-List and set the content to the values provided by the upper layers;

FIG. 2C illustrates RRC connection reconfiguration procedure.

Based on the reported capability and other factors such as required QoS and call admission control etc, the base station performs RRC reconfiguration procedure with the UE.

RRC reconfiguration procedure is a general purposed procedure that are applied to various use cases such as data radio bearer establishment, handover, cell group reconfiguration, DRX configuration, security key refresh and many others.

RRC reconfiguration procedure consists of exchanging RRCReconfiguration 2C11 and RRCReconfigurationComplete 2C61 between the base station and the UE.

RRCReconfiguration may comprises following fields and IEs:
>1: rrc-TransactionIdentifier field contains a RRC-TransactionIdentifier IE;
>1: radioBearerConfig field contains a RadioBearerConfig IE;
   >>2: radioBearerConfig field comprises configuration information for SRBs and DRBs via which RRC messages and user traffic are transmitted and received;
>1: secondaryCellGroup field contains a CellGroupConfig IE;
   >>2: secondaryCellGroup field comprises configuration information for secondary cell group;
   >>2: A cell group consists of a SpCell and zero or more SCells;
   >>2: Cell group configuration information comprises cell configuration information for SpCell/SCell and configuration information for MAC and configuration information for logical channel etc;
>1: measConfig field contains a MeasConfig IE;
   >>2: measConfig field comprises configuration information for measurements that the UE is required to perform for mobility and other reasons.
>1: masterCellGroup field contains a CellGroupConfig IE;

Upon reception of RRCReconfiguration, UE processes the IEs in the order as below. UE may:
>1: perform the cell group configuration for MCG based on the received masterCellGroup 2C21;
>1: perform the cell group configuration for SCG based on the received secondaryCellGroup 2C31;
>1: perform the radio bearer configuration based on the received radioBearerConfig 2C41;
>1: perform the measurement configuration based on the received measConfig 2C51;

After performing configuration based on the received IEs/fields, the UE transmits the RRCReconfigurationComplete to the base station. To indicate that the RRCReconfigurationComplete is the response to RRCReconfiguration, UE sets the TransactionIdentifier field of the RRCReconfigurationComplete with the value indicated in TransactionIdentifier field of the RRCReconfiguration.

FIG. 2D illustrates data transfer procedure in RRC_CONNECTED state.

The UE and the base station may perform procedures for power saving such as C-DRX 2D11. The configuration information for C-DRX is provided to the UE within cell group configuration in the RRCReconfiguration.

The UE and the base station may perform various procedures for downlink scheduling 2D21 such as CSI reporting and beam management. The configuration information for CSI reporting is provided to the UE within cell group configuration in the RRCReconfiguration. Beam management is performed across RRC layer and MAC layer and PHY layer. Beam related information is configured via cell group configuration information within RRCReconfiguration. Activation and deactivation of beam is performed by specific MAC CEs.

Based on the reported CSI and downlink traffic for the UE, the base station determines the frequency/time resource and transmission format for downlink transmission. The base station transmits to the UE DCI containing downlink scheduling information via PDCCH 2D31. The base station transmits to the UE PDSCH corresponding to the DCI and containing a MAC PDU 2D41.

The UE and the base station may perform various procedure for uplink scheduling 2D51 such as buffer status reporting and power headroom reporting and scheduling request and random access. The configuration information for those procedures are provided to the UE in cell group configuration information in RRCReconfiguration.

Based on the uplink scheduling information reported by the UE, the base station determines the frequency/time resource and transmission format for uplink transmission. The base station transmits to the UE DCI containing uplink scheduling information via PDCCH 2D61. The base station transmits to the UE PDSCH corresponding to the DCI and containing a MAC PDU 2D71.

The Synchronization Signal and PBCH block (SSB) 2E10 consists of primary synchronization signals (PSS) 2E20 and secondary synchronization signals (SSS) 2E30. PSS and SSS occupies 1 symbol and 127 subcarriers. PBCH 2E40 spans across 3 OFDM symbols and 240 subcarriers The possible time locations of SSBs within a half-frame are determined by sub-carrier spacing and the periodicity of the half-frames where SSBs are transmitted is configured by the network. During a half-frame, different SSBs may be transmitted in different spatial directions (i.e. using different beams, spanning the coverage area of a cell).

In NR communication system, system information is classified two types: Minimum System Information (MSI) and Other System Information (OSI). In the current NR system, MSI shall periodically broadcast. Dynamic/on-demand transmission is possible only for OSI, because resource/configuration for OSI request is provided in MSI while resource/configuration for MSI request cannot be provided in any other system information of the concerned cell.

If the base station can skip transmission of MSI as well, it would bring significant energy saving gain in network side. To make it happen, the principle that system information of a cell broadcasts only in the cell may need to be violated. The side-effect of violation can be minimized by not allowing legacy terminals (that are designed based on the principle) to access the cell.

To achieve network energy saving via efficient MSI transmission as described above, various types of cells are defined as in the table below.

TABLE 1

| | Type 0 Cell | Type 1 Cell | Type 2 Cell (non- | Type 3 Cell (non- |
|---|---|---|---|---|
| | (legacy/ | (anchor/ | anchor/assisted | anchor/assisted |
| | assisting cell) | assisting cell) | cell w/MIB) | cell w/light SSB) |
| Note | Legacy cell (Rel- | Cell (Rel-y cell; | Cell for network | saving (Rel-y |
| | x cell; x < 19) | y > 18) where on- | energy saving | cell; y > 18); |
| | where on-demand | demand MIS is | (Rel-y cell; | A specific part of |
| | MSI is not enabled/ | enabled/deployed; | y > 18); | system information |
| | deployed; | This cell provides | A specific part of | is provided in |
| | | a specific part | system information | the associated type |
| | | of system information | is provided in | 1 cell; |
| | | of non-anchor/ | the associated | MIB/SIB1 request |
| | | assisted cell; | type 1 cell; | information is |
| | | This cell provides | SIB1 request | provided in the as |
| | | information for | information | sociated type 1 |
| | | MSI request of n | is provided | cell. |
| | | on-anchor/assisted | in the associated | |
| | | cell. | type 1 cell. | |
| Access | Legacy UE | Legacy UE | Rel-y UE | Rel-y UE |
| allowed | (Rel-x UE); | (Rel-x UE); | implementing | implementing |
| to | Rel-y UE | Rel-y UE | this feature; | this feature; |
| | implementing | implementing | | |
| | this feature; | this feature; | | |
| | Rel-y UE not | Rel-y UE not | | |
| | implementing this | implementing this | | |
| | feature | feature | | |
| Preventing | N/A | N/A | An indication in | When MIB/SIB1 |
| access from | | | MIB | is not transmitted, |
| UEs not | | | | unavailability of |
| implementing | | | | MIB/SIB1 prevent |
| this feature | | | | access. |
| | | | | When MIB/SIB1 |
| | | | | is transmitted, an |
| | | | | indication in SIB1 |
| | | | | prevent such UEs |
| | | | | to access the |
| | | | | cell. |
| Candidate for | Yes (if SS-RSRP | Yes (if SS-RSRP | No (Even if SS-RSRP | No (Even if SS-RSRP |
| cell selection | and SS-RSRQ are | and SS-RSRQ are | and SS-RSRQ | and SS-RSRQ |
| | better than | better than | are better than | are better than |
| | S-Criteria, | S-Criteria, | S-Criteria, UE | S-Criteria, UE |
| | UE selects | UE selects | does not select | does not select |
| | the cell) | the cell) | the cell) | the cell) |
| Candidate for | Yes (if highest | Yes (if highest | Yes (if highest | Yes (if highest |
| cell reselection | ranked, UE can | ranked, UE can | ranked, UE can | ranked, UE can |
| | reselect the cell) | reselect the cell) | reselect the cell) | reselect the cell) |
| SSB | Normal SSB is | Normal SSB is | Normal SSB is | Light SSB is |
| | periodically | periodically | periodically | periodically |
| | transmitted | transmitted | transmitted | transmitted; |
| | | | | Normal SSB is |
| | | | | transmitted |
| | | | | on-demand |
| MSI | Both MIB and SIB1 | Both MIB and SIB1 | MIB is periodically | MIB/SIB1 is |
| | are periodically | are periodically | broadcast; | broadcast |
| | broadcast | broadcast | SIB1 is broadcast | on-demand |
| | | | on-demand | |
| OSI | Periodically broad | Periodically broad | broadcast | broadcast |
| | cast or broadcast | cast or broadcast | on-demand | on-demand |
| | on-demand | on-demand | | |
| Explicit Cell | cellBarred for its | cellBarred for its | cellBarred for its | cellBarred for its |
| Suitability | elf in MIB; | elf in MIB; | elf in MIB; | elf in MIB; |
| Information | cellBarredNTN for | cellBarredNTN for | cellBarredNTN for | cellBarredNTN for |
| (cellBarred; | itself in SIB1; | itself in SIB1; | itself in SIB1; | itself in SIB1; |
| cellBarredNTN; | cellBarredRedCap | cellBarredRedCap | cellBarredRedCap | cellBarredRedCap |
| cellBarredRedCap) | for itself in SIB1 | for itself in SIB1 | for itself in SIB1 | for itself in SIB1 |
| | | CellBarred/CellBarredNTN/ | | |
| | | CellBarredRedCap | | |
| | | for assisted | | |
| | | cell in SIB | | |
| | | 3 or SIB4 | | |
| Implicit Cell | PLMN-Identity InfoList | PLMN-IdentityInfoList | PLMN-IdentityInfoList | PLMN-IdentityInfoList |
| Suitability | for itself in | for itself in | for itself in | for itself in |
| Information | SIB1. | SIB1. | SIB1. | SIB1. |
| | | PLMN-IdentityInfoList | | |
| | | for assisted | | |
| | | cell in SIB3 or in | | |
| | | SIB4 | | |
| SI request | SI-RequestConfig | SI-RequestConfig | SI-RequestConfig | SI-RequestConfig |
| configuration | for itself in SIB1 | for itself in SIBI | for itself in SIB1 | for itself in SIB1 |
| for OSI | | | | |
| SI request | None | Index for MSI- | Index for MSI- | Index for MSI- |
| configuration | | RequestConfig for | RequestConfig in | RequestConfig in |
| for MSI | | assisted cell in | SIB3 or SIB4 of | SIB3 or SIB4 of |
| | | SIB3 or SIB4; | the anchor cell; | the anchor cell; |
| | | MSI-RequestConfig | MSI-RequestConfig | MSI-RequestConfig |
| | | in SIB 30 (new | in SIB 30 of the | in SIB 30 of the |
| | | SIB defined for | anchor cell | anchor cell |
| | | this feature) | | |

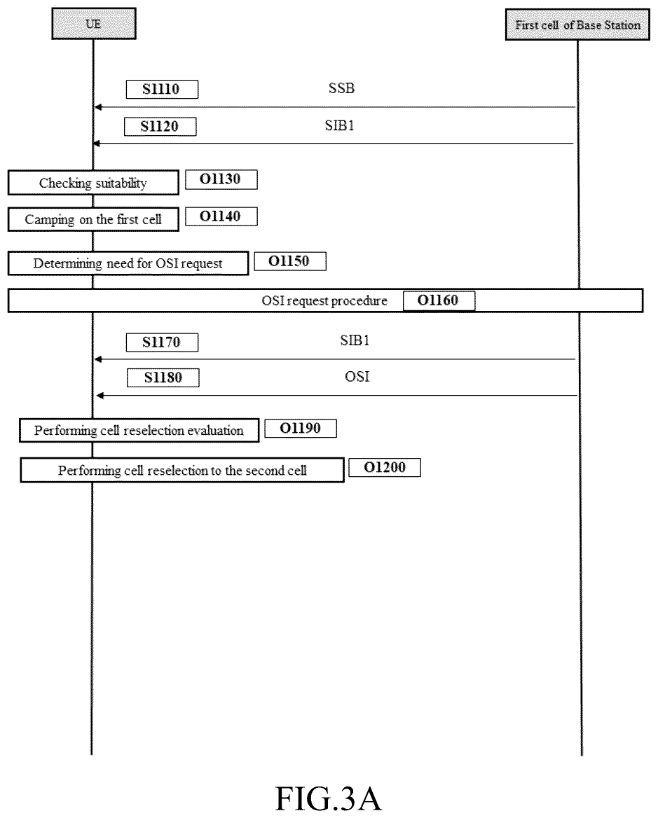

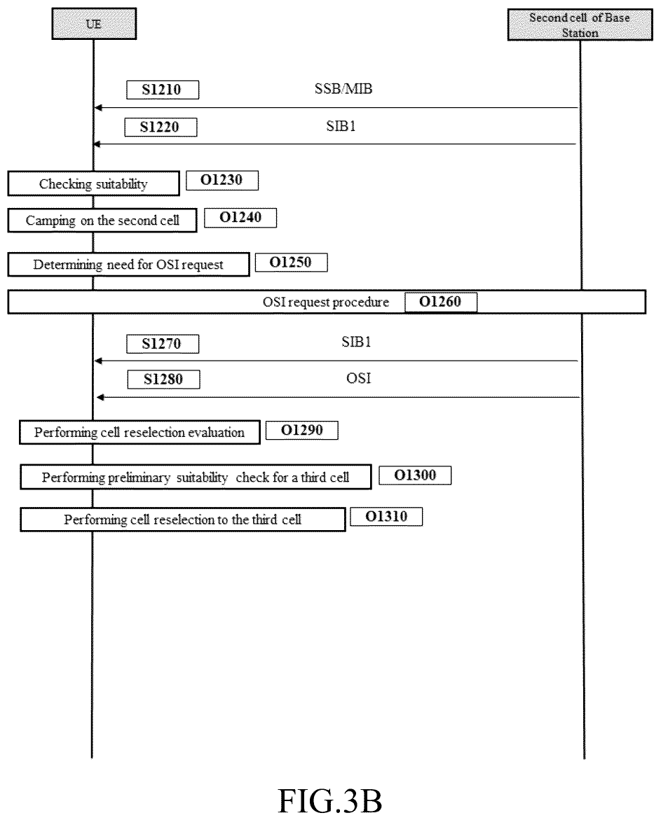

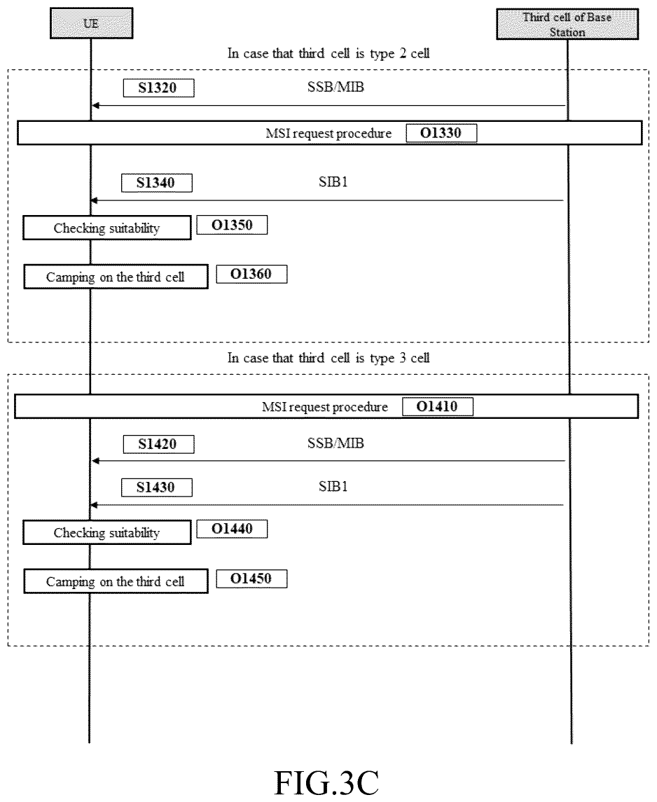

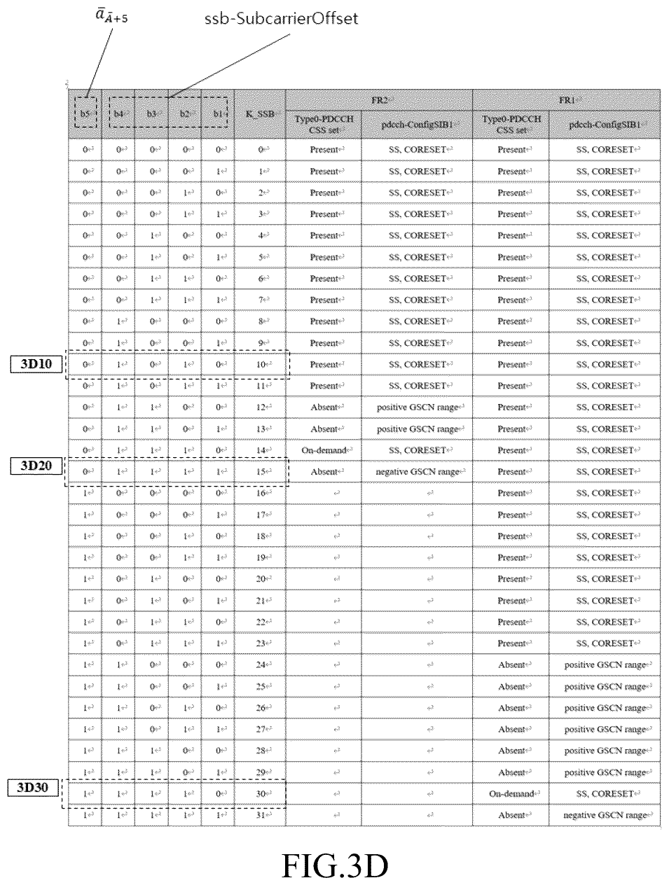

FIG. 3A, FIG. 3B and FIG. 3C illustrates the operations of UE and base station in various types of cells.

UE is operating in a network wherein:
# first cell is type 0 cell;
# second cell is type 1 cell; and
# third cell is type 2 cell or type 3 cell.

Upon selecting a first cell, UE receives SSBs of the first cell S1110. UE acquires MIB of the first cell in the SSB. UE determines CORESET and SS for SIB1 based on MIB.

UE receives SIB1 of the first cell S1120.

UE performs suitability check for the first cell O1130. UE determines whether the first cell is suitable or not based on explicit cell suitability information in SIB1 and in MIB. UE determines whether the first cell is suitable or not based on implicit cell suitability information in SIB1.

UE camps on the first cell O1140 if UE determines that the first cell is suitable.

UE determines whether OSI needs to be requested O1150 based on the scheduling information in the SIB1.

UE performs OSI request procedure O1160 based on SI-RequestConfig in SIB1 of the cell. UE selects a preamble corresponding to the OSI. Upon receiving the preamble in the random access time/frequency resource configured for OSI request, GNB notice that the OSI is requested. Provided that GNB notice OSI request during a modification period n, GNB does not schedule OSI during the current modification period (modification period n). GNB updates the scheduling information in SIB1 so that scheduling information of the OSI is indicated. GNB transmits the updated SIB1 in the next modification period (e.g. modification period n+1). GNB transmits the OSI during the next modification period (e.g. modification period n+2).

UE receives SIB1 S1170 to get the scheduling information for the OSI in a modification period.

UE receives other SIs S1180 based on SI-SchedulingInfo in SIB1 during the next modification period.

UE performs cell reselection evaluation process O1190 based on parameters comprised in SIB2, SIB3 and SIB4.

UE reselect a cell based on cell-ranking criterion for serving cell (Rs) and cell-ranking criterion for neighbouring cells (Rn).

If the Rn of the second cell is highest, UE reselects the second cell O1200.

UE receives SSBs of the second cell S1210. UE acquires MIB of the second cell in the SSB. UE determines CORESET and SS for SIB1 based on parameters in MIB. UE may have already received SSB and MIB during cell reselection evaluation process for the second cell.

UE receives SIB1 of the second cell S1220.

UE performs suitability check for the second cell O1230. UE determines whether the second cell is suitable or not based on explicit cell suitability information in SIB1 and in MIB. UE determines whether the second cell is suitable or not based on implicit cell suitability information in SIB1.

UE camps on the second cell O1240 if UE determines that the second cell is suitable.

UE determines that the second cell is type 1 cell in case that the second cell provides a specific SIB (e.g. SIB30) that contains the information regarding MSI request configuration for associated assisted cell. Alternatively, UE determines that the second cell is type1 cell in case that scheduling information in SIB1 indicates that SIB30 is part of a OSI. Alternatively, UE determines that the second cell is type 2 cell in case that MSI request configuration is provided in the system information.

UE determines whether OSI needs to be requested O1250 based on the scheduling information in the SIB1.

UE performs OSI request procedure O1260 based on SI-RequestConfig in SIB1 of the second cell.

UE receives SIB1 S1270 to get the scheduling information for the OSI in a modification period.

UE receives other SIs S1280 based on SI-SchedulingInfo in SIB1 during the next modification period.

UE performs cell reselection evaluation process O1290 based on parameters comprised in SIB2, SIB3 and SIB4.

For cell reselection evaluation process for intra-frequency neighbouring cells, UE may:
# determine types of intra-frequency neighbouring cells based on parameters in SIB3;
# determine candidate neighbouring cells based on parameters in SIB3;
# perform preliminary suitability check for candidate neighbouring cells based on parameters in SIB2 or parameters in SIB3; and
# performs measurement on SSBs of the candidate neighbouring cells that are determined to be suitable according to the preliminary suitability check.

For cell reselection evaluation process for inter-frequency neighbouring cells, UE may, for a specific frequency:
# determine types of inter-frequency neighbouring cells of the frequency based on parameters in SIB4;
# determine candidate neighbouring cells of the frequency based on parameters in SIB4;
# perform preliminary suitability check for candidate neighbouring cells of the frequency based on parameters in SIB2 or parameters in SIB4; and
# performs measurement on SSBs of the candidate neighbouring cells that are determined to be suitable according to the preliminary suitability check.

UE performs preliminary suitability check for a third cell O1300.

If third cell is determined to be suitable according to the preliminary suitability check and if the Rn of the third cell is highest, UE reselects the third cell O1310.

If the third cell is type 2 cell, UE receives SSB/MIB in the third cell S1320. UE determines whether the third cell is barred or not based on CellBarred in the MIB. If the third cell is not barred, UE may perform MSI request procedure O1330 based on MSI-RequestConfig in SIB30 of the cell associated with the current cell. UE transmits a preamble indicated in the MSI-RequestConfig. Upon receiving the preamble in the random access time/frequency resource configured for MSI request, GNB notice that the MSI is requested.

GNB transmits:
# PDCCH (downlink assignments) for SIB1 from a specific SS.
## The specific SS is the first SS of SSs indicated by PDCCH-ConfigSIB1 since the transmission/reception of the preamble.
# PDSCH carrying SIB1 according to the downlink assignment.

GNB may transmit PDCCH and PDSCH for SIB1 during a specific time period (msi_reception_window). The specific time period starts at the reception/transmission of the preamble and last for a specific time length which is indicated in the corresponding type_2_cell_info. GNB may transmit PDCCH for SIB1 in the next n SSs. n (msi_reception_window) is indicated in the corresponding type_2_cell_info. SSs for SIB1 transmission is determined based on the PRACH occasion where the preamble is transmitted/received and PDCCH-ConfigSIB1 in the MIB. To reduce the latency for MSI acquisition, modification period is not applied for MSI acquisition after MSI request (modification period is applied for OSI acquisition after OSI request). UE start monitoring SSs for MSI from the next SS for MSI (SS for MSI is determined from PDCCH-ConfigSIB1) after preamble transmission.

GNB may transmit SIB1 upon detection of MSI request. UE receives SIB1 S1340.

UE performs suitability check for the third cell O1350 based on explicit suitability parameters and implicit suitability parameters in MIB and SIB1.

UE camps on the third cell O1360 if the third cell is determined to be suitable.

If the third cell is type 3 cell, UE may perform MSI request procedure O1410. GNB may transmit SSB/MIB and SIB1 upon detection of MSI request. UE receives SSB/MIB S1420 and SIB1 S1430. UE transmits a preamble indicated in the MSI-RequestConfig. Upon receiving the preamble in the random access time/frequency resource configured for MSI request, GNB notice that the MSI is requested.

GNB transmits:
# MIB from a specific SSB position.
## The specific SSB position is the first SSB position (determined based on ssb-PositionInBurst) since the transmission/reception of the preamble.
# PDCCH (downlink assignment) for SIB1 in the SS indicated by PDCCH-ConfigSIB1; and
# PDSCH carrying SIB1 according to the downlink assignment.

GNB may transmit MIB and SIB1 during a specific time period (msi_reception_window). GNB may transmit MIB in the next n SSBs. GNB may transmit SIB1 in the next m SSs. n and m (msi_reception_window) are indicated in the corresponding type_3_cell_info.

To reduce the latency for MIB/SIB1 acquisition, modification period is not applied for MIB/SIB1 acquisition after MSI request (modification period is applied for OSI acquisition after OSI request). UE start receiving MIB and monitoring SSs for SIB1 from the next SSB and the next SS after preamble transmission.

UE performs suitability check for the third cell O1440 based on explicit suitability parameters and implicit suitability parameters in MIB and SIB1.

UE camps on the third cell O1450 if the third cell is determined to be suitable.

To camp on a cell, UE performs suitability check to see if the UE is allowed to access the cell (e.g. the cell is not barred; cell status is not barred).

If the third cell is type 0 cell or type 1 cell, suitability check (with which UE determines whether the cell is suitable or not) is performed in sequence and based on:
# the system information that is periodically broadcasting in BCH of the third cell; and
# the system information that is periodically broadcasting in DL-SCH of the third cell.

If the third cell is type 2 cell, suitability check is performed in sequence and based on:
# the system information that is periodically broadcasting in BCH of the third cell; and
# the system information that broadcast on demand (in response to MSI request) in DL-SCH of the third cell.

If the third cell is type 2 cell, suitability check is alternatively performed in sequence and based on:
# the system information [SIB3 or SIB4 or SIB1] that broadcast on demand (in response to OSI request) in DL-SCH of the second cell;
# the system information [cellBarred in MIB] that is periodically broadcasting in BCH of the third cell; and
# the system information [carrierBandwidth; frequencyBandList] that broadcast on demand (in response to MSI request) in DL-SCH of the third cell.

If the third cell is type 3 cell, suitability check is performed in sequence and based on:
# the system information that broadcast on demand (in response to the system information request) in BCH of the third cell; and
# the system information that broadcast on demand (in response to the system information request) in DL-SCH of the third cell.

If the third cell is type 3 cell, suitability check is alternatively performed in sequence and based on:
# the system information [cellBarred in SIB3 or SIB4; cellBarredXXX in SIB3 or SIB4; PLMNidentityInfo in SIB3 or SIB4 or SIB1] that broadcast on demand (in response to OSI request) in DL-SCH of the second cell;
# the system information [carrierBandwidth; frequencyBandList] that broadcast on demand (in response to MSI request) in DL-SCH of the third cell.

For suitability check of type 1 cell, system information request is not performed before the suitability check.

For suitability check of type 2 cell, system information request is performed before the suitability check and SIB1 acquisition and after MIB acquisition.

For suitability check of type 3 cell, system information request is performed before the suitability check and SIB1 acquisition and MIB acquisition.

For suitability check of type 2 or type 3 cell, system information request is required. System information request consumes power of terminal and power of base station. Hence MSI request for suitability check should be avoided as much as possible. One possible way is to provide the necessary information for suitability check in the associated assisting cells. In this case, the UE performs MSI request procedure in the assisted cell only when the assisted cell is suitable cell.

### <OSI Request Procedure>

For OSI request in a cell, UE performs following based on relevant parameters in SIB1 of the cell:
# UE determines that SI y is OSI to be requested if:
## SIB x is required for UE to operate in the cell;
## SI y containing the SIB x is indicated notBroadcasting in the corresponding si-SchedulingInfo;
# UE determines a one or more Random Access Preambles associated with the SI y based on ra-PreambleStartIndex in SI-RequestResources corresponding to the SI y
# UE initiates a random access procedure in the initial uplink/downlink BWP in the cell.
## configuration for initial uplink/downlink BWP is provided in ServingCellConfigCommon in the SIB1.
# UE performs Msg1 transmission as follows:
## UE selects an SSB with SS-RSRP above rsrp-ThresholdSSB in RACH-ConfigGeneric in SI-RequestConfig;
## UE selects a Random Access Preamble corresponding to the selected SSB, from the Random Access Preamble(s) determined according to ra-PreambleStartIndex.
### UE sets the PREAMBLE_INDEX accordingly.
## UE determines the next available available PRACH occasion from the PRACH occasions corresponding to the selected SSB in the association period given by ra-AssociationPeriodIndex in the si-RequestPeriod permitted by the restrictions given by the ra-ssb-OccasionMaskIndex if configured.
## UE transmits the Random Access Preamble in the next available PRACH occasion with a specific transmission power.
# UE performs Msg 2 reception as follows:
## UE starts ra-ResponseWindow configured in RACH-ConfigGeneric in SI-RequestConfig.
## UE monitor the PDCCH of the initial downlink BWP for Random Access Response(s) identified by the RA-RNTI while the ra-ResponseWindow is running.
# UE considers the random access procedure for OSI request is successful if:
## a valid downlink assignment has been received on the PDCCH for the RA-RNTI;
## the received TB is successfully decoded; and
## the Random Access Response contains a MAC subPDU with Random Access Preamble identifier corresponding to the transmitted PREAMBLE_INDEX.
# UE considers Random Access Response reception not successful if:
## ra-ResponseWindow configured in RACH-ConfigGeneric expires; and
## the Random Access Response containing Random Access Preamble identifiers that matches the transmitted PREAMBLE_INDEX has not been received.
# UE acquires the requested SI message (s) in case that random access procedure for OSI request is successful.
# UE performs followings in case that Random Access Response reception not successful:
## UE sets a random backoff time according to a uniform distribution between 0 and the PREAMBLE_BACKOFF;
## UE performs Msg1 transmission with adjusted power (increased transmission power by PREAMBLE_POWER_RAMPING_STEP in RACH-ConfigGeneric).
## UE performs Msg 2 reception.

### <Determining_Types_of_Intra_Freq_Meighbouring_Cells>

UE may:
# determine a neighboring cell is type 2 cell in case that the cell is indicated in a intra_Freq_type_2_cell_list in SIBb 3;
# determine a neighboring cell is type 3 cell in case that the cell is indicated in a intra_Freq_type_3_cell_list in SIB3;
# determine a neighboring cell is type 0 cell or type 1 cell in case that the cell is indicated neither in a intra_Freq_type_2_cell_list in SIB3 nor in a intra_Freq_type_3_cell_list in SIB3.

### <Determining_Candidate_Intra_Freq_Neighbouring_Cells>

To prevent access from normal terminal, assisted cell is included in excluded_list. Meanwhile, for NES UE to access the assisted cell, NES UE treats assisted cell in the excluded_list as candidate for cell reselection.

UE may:
# if intraFreqExcludedCellList is present;
# if intraFreqAllowedCellList is absent; and
# if intra_Freq_type_X_cell_list is present (x=2 or 3);
## if a PCI of a cell is indicated in the intraFreqExcludedCellList and indicated in the intra_Freq_type_X_cell_list;
### consider the cell as candidate for intra-frequency cell reselection;
## if a PCI of a cell is indicated in the intraFreqExcludedCellList and not indicated in the intra_Freq_type_X_cell_list;
### not consider the cell as candidate for intra-frequency cell reselection;
## if a PCI of a cell is not indicated in the intraFreqExcludedCellList and indicated in the intra_Freq_type_X_cell_list;
### consider the cell as candidate for intra-frequency cell reselection;
## if a PCI of a cell is not indicated in the intraFreqExcludedCellList and not indicated in the intra_Freq_type_X_cell_list;
### consider the cell as candidate for intra-frequency cell reselection;

To prevent access from normal terminal, assisted cell is not included in allowed_list. Meanwhile, for NES UE to access the assisted cell, NES UE treats assisted cell not in the allowed_list as candidate for cell reselection.

UE may:
# if intraFreqExcludedCellList is absent;
# if intraFreqAllowedCellList is present; and
# if intra_Freq_type_X_cell_list is present (x=2 or 3);
## if a PCI of a cell is indicated in the intraFreqAllowedCellList and indicated in the intra_Freq_type_X_cell_list;
### consider the cell as candidate for intra-frequency cell reselection;
## if a PCI of a cell is indicated in the intraFreqAllowedCellList and not indicated in the intra_Freq_type_X_cell_list;
### consider the cell as candidate for intra-frequency cell reselection;
## if a PCI of a cell is not indicated in the intraFreqAllowedCellList and indicated in the intra_Freq_type_X_cell_list;
### consider the cell as candidate for intra-frequency cell reselection;
## if a PCI of a cell is not indicated in the intraFreqAllowedCellList and not indicated in the intra_Freq_type_X_cell_list;
### consider the cell as candidate for intra-frequency cell reselection.

### <Preliminary_Suitability_Check_on_Candidate_Cell>

UE may, for each candidate neighbouring cell:
# if the candidate neighbouring cell is type 2/3 cell:
## determine whether the cell is suitable/barred or not based on explicit suitability information such as:
### cellBarred field in the SIB3 or SIB4 of the associated assisting cell;
### cellBarredNTN in the SIB3 or SIB4 of the associated assisting cell;
### cellReservedForOtherUse in the SIB3 or SIB4 of the associated assisting cell;
### cellReservedForFutureUse in the SIB3 or SIB4 of the associated assisting cell;
## determine whether the cell is suitable/barred or not based implicit suitability information such as:
### PLMN-IdentityInfoList in the SIB3 or SIB4 or SIB2 of the associated assisting cell;
#### plmn-IdentityList;
#### trackingAreaCode;
#### cellReservedForOperatorUse;
## determine to reselect the cell if the cell is determined suitable in the preliminary suitability check.

### <Suitability_Check_on_Reselected_Cell>

UE may:
# if the reselected cell is assisting cell (e.g. type 0 or type1):
## acquire MIB of the reselected cell;
## acquire SIB1 of the reselected cell based on CORESET 0 and SS 0 indicated in the MIB;
## determine whether the cell is suitable/barred or not based on explicit suitability information such as:
### cellBarred field in the MIB;
### RedCap-ConfigCommonSIB in SIB1; and
### cellBarredNTN in SIB1;
### cellReservedForOtherUse in SIB1;
### cellReservedForFutureUse in SIB1;
## determine whether the cell is suitable/barred or not based implicit suitability information such as:
### PLMN-IdentityInfoList in SIB1;
#### plmn-IdentityList;
#### trackingAreaCode;
#### cellReservedForOperatorUse;
## determine to camp on the cell if the cell is determined suitable;
# if the reselected cell is type 2 cell:
## acquire MIB of the cell;
## perform MSI request procedure to request SIB1;
## acquire SIB1 of the reselected cell based on CORESET 0 and SS 0 indicated in the MIB;
## determine whether the cell is suitable/barred or not based on explicit suitability information such as:
### cellBarred field in the MIB;
### RedCap-ConfigCommonSIB in SIB1; and
### cellBarredNTN in SIB1;
### cellReservedForOtherUse in SIB1;
### cellReservedForFutureUse in SIB1;
## determine whether the cell is suitable/barred or not based implicit suitability information such as:
### PLMN-IdentityInfoList in SIB1;
#### plmn-IdentityList;
#### trackingAreaCode;
#### cellReservedForOperatorUse;
## determine to camp on the cell if the cell is determined suitable;
# if the reselected cell is type 3 cell:
## perform MSI request procedure to request MIB;
## acquire SIB1 of the reselected cell based on CORESET 0 and SS 0 indicated in the MIB;
## determine whether the cell is suitable/barred or not based on explicit suitability information such as:
### cellBarred field in the MIB;
### RedCap-ConfigCommonSIB in SIB1; and
### cellBarredNTN in SIB1;
### cellReservedForOtherUse in SIB1;
### cellReservedForFutureUse in SIB1;
## determine whether the cell is suitable/barred or not based implicit suitability information such as:
### PLMN-IdentityInfoList in SIB1;
#### plmn-IdentityList;
#### trackingAreaCode;
#### cellReservedForOperatorUse;
## determine to camp on the cell if the cell is determined suitable.

### <Determining_Types_of_Inter_Freq_Neighbouring_Cells>

UE may, for a non-serving frequency listed in interFreqCarrierFreqList in SIB4:
# determine a neighboring cell of the frequency is type 2 cell in case that the cell is indicated in a type_2_cell_list in interFreqCarrierFreqInfo corresponding to the frequency in SIB4;
# determine a neighboring cell is type 3 cell in case that the cell is indicated in a type_3_cell_list in SIB3;
# determine a neighboring cell is type 0 cell or type 1 cell in case that the cell is indicated neither in a type_2_cell_list in SIB3 nor in a type_3_cell_list in SIB3.

### <MSI_Request_Procedure_Type2_Assisted_Cell>

For MSI request for a first cell, UE performs following based on relevant parameters in SIB3 and SIB30 of associated assisting cell:
# UE determines that MSI for the first cell is to be requested if:
## the first cell is highest ranked cell;
## the first cell is type 2 assisted cell; and
## the serving cell (associated assisting cell) provides msi_Request_id for the first cell.
# UE receives MIB of the first cell.
# UE determines a Random Access Preambles associated with the MSI based on the msi_Request_id (or Random Access Preamble associated with the MSI is fixed in the specification);
# UE initiates a type 2 random access procedure in a BWP determined based on the msi_Request_id.
## configuration for the BWP is provided in Msi_Request_Config corresponding to the msi_Request_id.
# UE performs Msg1 transmission as follows:
## UE selects an SSB with SS-RSRP above rsrp-ThresholdSSB in RACH-ConfigGeneric in MSI-RequestConfig;
## UE determines the next available PRACH occasion from the PRACH occasions corresponding to the selected SSB in the association period.
## UE transmits the Random Access Preamble in the next available PRACH occasion with a specific transmission power.
# UE performs MSI reception as follows:
## UE starts msi_reception_window from the closet selected SSB (e.g the next selected SSB).
## UE consider MSI reception to be successful in case that UE successfully acquires SIB1 while the msi_reception_window is running.
# UE considers MSI reception is not successful if
## msi_reception_window expires; and
## SIB1 has not been received.
# UE performs followings in case that MSI reception is not successful:
## UE performs Msg1 transmission with adjusted power (increased transmission power by PREAMBLE_POWER_RAMPING_STEP in RACH-ConfigGeneric in MSI-RequestConfig).
## UE performs MSI reception.
# UE consider MSI request procedure is unsuccessfully completed if PREAMBLE_TRANSMISSION_COUNTER=preambleTransMax+1 (preambleTransMax is indicated in RACH-ConfigGeneric in MSI-RequestConfig).

### <MSI_Request_Procedure_Type3_Assisted_Cell>

For MSI request for a first cell, UE performs following based on relevant parameters in SIB3 and SIB30 of associated assisting cell:
# UE determines that MSI for the first cell is to be requested if:
## the first cell is highest ranked cell;
## the first cell is type 3 assisted cell; and
## the serving cell (associated assisting cell) provides msi_Request_id for the first cell.
# UE determines a Random Access Preambles associated with the MSI based on the msi_Request_id;
# UE initiates a random access procedure in a BWP determined based on the msi_Request_id.
## configuration for the BWP is provided in Msi_Request_Config corresponding to the msi_Request_id.
# UE performs Msg1 transmission as follows:
## UE selects an SSB with SS-RSRP above rsrp-ThresholdSSB in RACH-ConfigGeneric in MSI-RequestConfig;
## UE determines the next available PRACH occasion from the PRACH occasions corresponding to the selected SSB in the association period.
## UE transmits the Random Access Preamble in the next available PRACH occasion with a specific transmission power.
# UE performs MSI reception as follows:
## UE starts msi_reception_window from the closet selected SSB (e.g the next selected SSB).
## UE consider MSI reception is successful in case that UE successfully acquire MIB during the msi_reception_window is running.
# UE considers MSI reception is not successful if
## msi_reception_window expires; and
## MIB has not been received.
# UE performs followings in case that MSI reception is not successful:
## UE performs Msg1 transmission with adjusted power (increased transmission power by PREAMBLE_POWER_RAMPING_STEP in RACH-ConfigGeneric in MSI-RequestConfig).
## UE performs MSI reception.
# UE consider MSI request procedure is unsuccessfully completed if PREAMBLE_TRANSMISSION_COUNTER=preambleTransMax+1 (preambleTransMax is indicated in RACH-ConfigGeneric in MSI-RequestConfig)

To acquire SIB1 in a first cell, UE may perform followings:
# receiving, by the terminal in the first cell, a SSB; and
# performing, by the terminal in the first cell, either MSI request procedure or SIB1 acquisition procedure,
# wherein, in case that the first cell is in FR1:
## the specific time duration is indicated by a parameter comprised in a second cell.
## in case that ssb-SubcarrierOffset indicates 14 and a specific bit of PBCH payload is 1:
### SIB1 is provided on-demand in the cell;
### Type0-PDCCH CSS set is present on-demand in the cell;
### CORESET and SS for SIB1 reception are provided in pdcch-ConfigSIB1; and
### Terminal initiates MSI request procedure (SS for SIB1 is monitored by the terminal for a specific time duration after preamble for MSI request is transmitted);
## in case that ssb-SubcarrierOffset indicates 14 and a specific bit of PBCH payload is 0:
### SIB1 is provided periodically in the cell;
### Type0-PDCCH CSS set is present in the cell;
### CORESET and SS for SIB1 reception are provided in pdcch-ConfigSIB1; and
### Terminal initiates SIB1 acquisition procedure (SS for SIB1 is monitored by the terminal for a second specific time duration after MIB reception, based on PDCCH-ConfigSIB1).
## in case that ssb-SubcarrierOffset indicates one value between 8˜13 and a specific bit of PBCH payload is 1:
### SIB1 is not provided in the cell;
### Type0-PDCCH CSS set is not present in the cell;
### pdcch-ConfigSIB1 indicates nearest GSCN of SSB having a CORESET for an associated Type0-PDCCH CSS set; and
### Terminal consider the cell as barred;
## in case that ssb-SubcarrierOffset indicates 8˜13 and a specific bit of PBCH payload is 0:
### SIB1 is provided periodically in the cell;
### Type0-PDCCH CSS set is present in the cell;
### CORESET and SS for SIB1 reception are provided in pdcch-ConfigSIB1; and
### Terminal initiates SIB1 acquisition procedure (SS for SIB1 is monitored by the terminal for a second specific time duration after MIB reception, based on PDCCH-ConfigSIB1).
## in case that ssb-SubcarrierOffset indicates 15 and a specific bit of PBCH payload is 1:
### SIB1 is not provided in the cell;
### Type0-PDCCH CSS set is not present in the cell;
### pdcch-ConfigSIB1 indicates a GSCN range within which SSB having a CORESET for an associated Type0-PDCCH CSS set does not exist; and
### Terminal consider the cell as barred;
## in case that ssb-SubcarrierOffset indicates 15 and a specific bit of PBCH payload is 0:
### SIB1 is provided periodically in the cell;
### Type0-PDCCH CSS set is present in the cell;
### CORESET and SS for SIB1 reception are provided in pdcch-ConfigSIB1; and
### Terminal initiates SIB1 acquisition procedure (SS for SIB1 is monitored by the terminal for a second specific time duration after MIB reception, based on PDCCH-ConfigSIB1).
## in case that ssb-SubcarrierOffset indicates one value between 0 and 7 and a specific bit of PBCH payload is 0 or 1:
### SIB1 is provided periodically in the cell;
### Type0-PDCCH CSS set is present in the cell;
### CORESET and SS for SIB1 reception are provided in pdcch-ConfigSIB1; and
### Terminal initiates SIB1 acquisition procedure (SS for SIB1 is monitored by the terminal for a second specific time duration after MIB reception, based on PDCCH-ConfigSIB1).
# wherein, in case that the first cell is in FR2:
## in case that ssb-SubcarrierOffset indicates 14:
### SIB1 is provided on-demand in the cell;
### Type0-PDCCH CSS set is present on-demand in the cell;
### CORESET and SS for SIB1 reception are provided in pdcch-ConfigSIB1; and
### The terminal initiates MSI request procedure (SS for SIB1 is monitored by the terminal for a specific time duration after preamble for MSI request is transmitted);
## in case that ssb-SubcarrierOffset indicates either 12 or 13:
### SIB1 is not provided in the cell;
### Type0-PDCCH CSS set is not present in the cell;
### pdcch-ConfigSIB1 indicates nearest GSCN of SSB having a CORESET for an associated Type0-PDCCH CSS set; and
### Terminal consider the cell as barred;
## in case that ssb-SubcarrierOffset indicates 15:
### SIB1 is not provided in the cell;
### Type0-PDCCH CSS set is not present in the cell;
### pdcch-ConfigSIB1 indicates a GSCN range within which SSB having a CORESET for an associated Type0-PDCCH CSS set does not exist; and
### Terminal consider the cell as barred;
## in case that ssb-SubcarrierOffset indicates one value between 0 and 11:
### SIB1 is provided periodically in the cell;
### Type0-PDCCH CSS set is present in the cell;
### CORESET and SS for SIB1 reception are provided in pdcch-ConfigSIB1; and
### Terminal initiates SIB1 acquisition procedure (SS for SIB1 is monitored by the terminal for a second specific time duration after MIB reception).
# In case that -SubcarrierOffset indicates 14:
## Terminal initiates MSI request procedure in case of FR2; or
## Terminal initiates MSI request procedure in case of FR1 and a specific bit of PBCH payload being 1; or
## Terminal initiates SIB1 acquisition procedure in case of FR1 and the specific bit of PBCH payload being 0.

All in all, UE determines SIB1 acquisition related parameters as in FIG. 3D.

In case of 3D10, where:
# b5 (specific bit of the PBCH payload) is equal to 0;
# sub-SubcarrierOffset is equal to 10, UE in FR2 cell determines that:
# Type0-PDCCH CSS set is present in the cell;
# pdcch-ConfigSIB1 indicates SS and CORESET for SIB1 reception.

UE in FR1 cell determines that:
# Type0-PDCCH CSS set is present in the cell;
# pdcch-ConfigSIB1 indicates SS and CORESET for SIB1 reception (e.g. “SIB1 reception” is equivalent to “Type0-PDCCH CSS set monitoring”).

In case of 3D20, where:
# b5 (specific bit of the PBCH payload) is equal to 0;
# sub-SubcarrierOffset is equal to 15, UE in FR2 cell determines that:
# Type0-PDCCH CSS set is absent in the cell;
# pdcch-ConfigSIB1 indicates negative GSCN based on which the UE determines the frequency location of second SS/PBCH block.

UE in FR1 cell determines that:
# Type0-PDCCH CSS set is present in the cell;
# pdcch-ConfigSIB1 indicates SS and CORESET for SIB1 reception.

In case of 3D30, where:
# b5 (specific bit of the PBCH payload) is equal to 1;
# sub-SubcarrierOffset is equal to 15, UE in FR1 cell determines that:
# Type0-PDCCH CSS set is present in the cell for on-demand SIB1;
# pdcch-ConfigSIB1 indicates SS (time domain pattern) and CORESET (frequency resource) for SIB1 reception.

For essential system information acquisition, The UE shall:
# if in RRC_IDLE or in RRC_INACTIVE or in RRC_CONNECTED while T311 is running:
## if the UE is unable to acquire the MIB:
### consider the cell as barred;
### perform barring as if intraFreqReselection, or intraFreqReselectionRedCap for RedCap UEs, is set to allowed;
## else if the UE is unable to acquire the SIB1:
### consider the cell as barred;
### if the UE is a RedCap UE:
#### perform barring as if intraFreqReselectionRedCap is set to allowed;
### else:
#### perform cell re-selection to other cells on the same frequency as the barred cell.

UE performs followings:
# Applying the specified BCCH configuration;
# Acquiring MIB in a first cell;
# Performing cell reselection to a second cell based on SIB1 reception in the first cell,
# Wherein, cell reselection to the second cell is performed in case that:
## the first cell is first type cell [assisting cell]; and
## SubcarrierOffset indicates a first value [13] or a second value [14](the first cell does not provide SIB1).
# Wherein, cell reselection to the second cell is performed in case that:
## the first cell is second type cell; and
## SubcarrierOffset indicates the first value [13](the first cell does not provide SIB1).
# Wherein, cell reselection to the second cell is performed in case that:
## the first cell is second type cell;
## SubcarrierOffset indicates the second value [14](the first cell provides SIB1 in on-demand manner); and
## MSI request procedure is not successfully completed in the first cell In case that:
# the current cell is first type cell;
# the cell provides SIB1 (k_ssb is in the first range); and
# UE fails to receive SIB1,

UE:
# consider the cell as barred; and
# performs cell reselection based on IFRI in MIB.

In case that:
# the current cell is first type cell;
# the cell does not provide SIB1 (k_ssb is in the second range) and
# UE fails to receive SIB1 (SIB1 is not successfully received during a specific duration of time),

UE:
# consider the cell as barred; and
# performs cell reselection based on IFRI in MIB.

In case that:
# the current cell is second type cell;
# the cell does provide SIB1 in on-demand manner (k_ssb is a specific value which is neither in in the second range nor in the first range) and
# MSI request procedure fails (SIB1 is not transmitted/received after n times of preamble transmission),

UE:
# consider the cell as barred; and
# performs cell reselection based on IFRI in MIB.

For system information acquisition, UE performs followings.

At 4A10, UE receives in the first cell a synchronization signal physical broadcast channel block (SSB); and

At 4A20, UE performs in the first cell a procedure for system information acquisition,

The SSB comprises:
a primary synchronization signal;
a secondary synchronization signal; and
a transport block,

The transport block comprises:
a first set of bits corresponding to master information block; and
a second set of bits appended to the first set of bits,

An index value [k_ssb] is determined based on:
a specific bit in the second set of bits; and
a specific field of the master information block,

The first procedure [MSI acquisition] is performed for system information acquisition in case that:
the frequency band of the first cell belongs to a first frequency region [FR2]; and
the index value is equal to a first specific value [14],

The second procedure [OSI acquisition] is performed for system information acquisition in case that:
the frequency band of the first cell belongs to a first frequency region [FR2];
the index value is within a first range [0˜11]; and
a scheduling information of a second system information [e.g. SI containing required SIB] indicates that the second system information is not broadcasting,
The first procedure is to request a first system information; and
The second procedure is to request the second system information, and
The first system information comprises the scheduling information of the second system information; and
The second system information comprises one or more system information blocks.

The first procedure [MSI acquisition] is performed in case that:
the frequency band of the first cell belongs to a second frequency region [FR1]; and
the index value is equal to a second specific value [30], and

The second procedure [OSI acquisition] is performed in case that:
the frequency band of the first cell belongs to the second frequency region [FR1];
the index value is within a second range [0˜23]; and
the scheduling information of the second system information [e.g. SI containing required SIB] indicates that the second system information is not broadcasting.

One or more random access preambles are transmitted in the first cell based on:
set of random access resource parameters comprised in a third system information [SIB30] in a second cell [associated assisting cell] in case that the first procedure is performed; and
set of random access resource parameters comprised in the first system information in the first cell in case that the second procedure is performed.

The first system information is acquired:
after the one or more random access preambles are transmitted in case that:
   the frequency band of the first cell belongs to the first frequency region [FR2]; and
   the index value is equal to the first specific value, and before the one or more random access preambles are transmitted in case that:
   the frequency band of the first cell belongs to the first frequency region [FR2]; and
   the index value is within the first range.

The first system information is acquired:
after the one or more random access preambles are transmitted in case that:
   the frequency band of the first cell belongs to the second frequency region [FR1]; and
   the index value is equal to the second specific value, and
before the one or more random access preambles are transmitted in case that:
   the frequency band of the first cell belongs to the second frequency region [FR1]; and
   the index value is within the second range.

The second specific field [pdcch-ConfigSIB1] of the master information block is applied:
after the first procedure is started in case that:
   the frequency band of the first cell belongs to the second frequency region [FR1]; and
   the index value is equal to the second specific value, and
before the second procedure is started in case that:
   the frequency band of the first cell belongs to the second frequency region [FR1]; and
   the index value is within the second range.

The second specific field comprises:
a first set of bits indicating set of time resource occurring periodically; and
a second set of bits indicating set of contiguous frequency resource blocks.

The specific field comprises a 4 bit information and the 4 bit information corresponds to least significant bits of the index value.

The specific bit in the second set of bits corresponds to most significant bit of the index value.

The terminal determines that type zero PDCCH CSS set:
is present in the first cell in case that the index value is within the first range;
will (can) be present in the first cell in case that the index value is the first specific value; and
is not and will not be present in the first cell in case that the index value is neither within the first range nor the first specific value.
type zero PDCCH CSS set defines a set of resources for transmission of PDCCH for SIB1. It is associated with a control resource set 0 which is defined based on the SSB. During time/frequency resource defined by type zero PDCCH CSS set and CORESET zero, UE monitors PDCCH for SIB1 reception. That type zero PDCCH CSS set is present in a cell means that SIB1 is provided in the cell. That type zero PDCCH CSS set is not present means that SIB1 is not provided in the cell. That type zero PDCCH CSS set will be present (or can be present) means that SIB1 will be provided if requested by a terminal.

In the time domain, an SS/PBCH block consists of 4 OFDM symbols, numbered in increasing order from 0 to 3 within the SS/PBCH block, where PSS, SSS, and PBCH with associated DM-RS are mapped to symbols.

In the frequency domain, an SS/PBCH block consists of 240 contiguous subcarriers with the subcarriers numbered in increasing order from 0 to 239 within the SS/PBCH block.

For operation with shared spectrum channel access in FR2-2 and for operation without shared spectrum channel access, the 4 least significant bits of k_SSB are given by the higher-layer parameter ssb-SubcarrierOffset and for FR1 the most significant bit of k_SSB is given by a[A+5] in the PBCH payload.

If ssb-SubcarrierOffset is not provided, k_SSB is derived from the frequency difference between the SS/PBCH block and Point A.

The bits in a PBCH transport block delivered to layer 1 are denoted by a[0], a[1], a[3], . . . , a[A−1], where A is the payload size generated by higher layers while the lowest order information bit a[0] is mapped to the most significant bit of the transport block.

The following additional timing related PBCH payload bits a[A], a[A+1], a[A+2], . . . a[A+7], where:
# a[A], a[A+1], a[A+2], a[A+3] are the 4^{th}, 3^{rd}, 2^{nd} and 1^{st} LSB of SFN, respectively;
# a[A+4] is the half frame bit;
# a[A+5] is the MSB of k_SSB;
# a[A+6] is reserved; and
# a[A+6] is the MSB of candidate SS/PBCH block index.

PBCH transport block contains MIB.

System Information (SI) consists of a MIB and a number of SIBs, which are divided into Minimum SI and Other SI:
# Minimum SI comprises basic information required for initial access and information for acquiring any other SI. Minimum SI consists of:
## MIB contains cell barred status information and essential physical layer information of the cell required to receive further system information, e.g. CORESET #0 configuration. MIB is periodically broadcast on BCH.
## SIB1 defines the scheduling of other system information blocks and contains information required for initial access. SIB1 is also referred to as Remaining Minimum SI (RMSI) and is periodically broadcast on DL-SCH or sent in a dedicated manner on DL-SCH to UEs in RRC_CONNECTED.
# Other SI encompasses all SIBs not broadcast in the Minimum SI. Those SIBs can either be periodically broadcast on DL-SCH, broadcast on-demand on DL-SCH (i.e. upon request from UEs in RRC_IDLE, RRC_INACTIVE, or RRC_CONNECTED), or sent in a dedicated manner on DL-SCH to UEs in RRC_CONNECTED (i.e., upon request, if configured by the network, from UEs in RRC_CONNECTED or when the UE has an active BWP with no common search space configured or when the UE configured with inter cell beam management is receiving DL-SCH from a TRP with PCI different from serving cell's PCI). Other SI consists of:
## SIB2 contains cell re-selection information, mainly related to the serving cell;
## SIB3 contains information about the serving frequency and intra-frequency neighbouring cells relevant for cell re-selection (including cell re-selection parameters common for a frequency as well as cell specific re-selection parameters);
## SIB4 contains information about other NR frequencies and inter-frequency neighbouring cells relevant for cell re-selection (including cell re-selection parameters common for a frequency as well as cell specific re-selection parameters), which can also be used for NR idle/inactive measurements;
## SIB5 contains information about E-UTRA frequencies and E-UTRA neighbouring cells relevant for cell re-selection (including cell re-selection parameters common for a frequency as well as cell specific re-selection parameters);
## SIB6 contains an ETWS primary notification;
## SIB7 contains an ETWS secondary notification;
## SIB8 contains a CMAS warning notification;
## SIB9 contains information related to GPS time and Coordinated Universal Time (UTC);
## SIB10 contains the Human-Readable Network Names (HRNN) of the NPNs listed in SIB1;
## SIB11 contains information related to idle/inactive measurements;
## SIB15 contains information related to disaster roaming;
## SIB16 contains slice-based cell reselection information;
## SIB17 contains information related to TRS configuration for UEs in RRC_IDLE/RRC_INACTIVE;
## SIBpos contains positioning assistance data as defined in TS 37.355 [43] and TS 38.331 [12];
## SIB18 contains information related to the Group IDs for Network selection (GINs) associated with SNPNs listed in SIB1.
## SIB30 contains information related to MSI request procedure.

The MIB is mapped on the BCCH and carried on BCH while all other SI messages are mapped on the BCCH, where they are dynamically carried on DL-SCH. The scheduling of SI messages part of Other SI is indicated by SIB1.

For UEs in RRC_IDLE and RRC_INACTIVE while SDT procedure is not ongoing (see clause 18), a request for Other SI triggers a random access procedure (see clause 9.2.6) where MSG3 includes the SI request message unless the requested SI is associated to a subset of the PRACH resources, in which case MSG1 is used for indication of the requested Other SI. When MSG1 is used, the minimum granularity of the request is one SI message (i.e. a set of SIBs), one RACH preamble and/or PRACH resource can be used to request multiple SI messages and the gNB acknowledges the request in MSG2. When MSG 3 is used, the gNB acknowledges the request in MSG4.

The Other SI may be broadcast at a configurable periodicity and for a certain duration. The Other SI may also be broadcast when it is requested by UE in RRC_IDLE/RRC_INACTIVE/RRC_CONNECTED.

For a UE to be allowed to camp on a cell it must have acquired the contents of the Minimum SI from that cell. There may be cells in the system that do not broadcast the Minimum SI and where the UE therefore cannot camp.

Change of system information (other than for ETWS/CMAS) only occurs at specific radio frames, i.e. the concept of a modification period is used. System information may be transmitted a number of times with the same content within a modification period, as defined by its scheduling. The modification period is configured by system information.

In case that SIB1 transmission starts based on MSI request procedure, the concept of the modification period is not applied. SIB1 transmission can starts in the middle of the modification period.

When the network changes (some of the) system information, it first notifies the UEs about this change, i.e. this may be done throughout a modification period. In the next modification period, the network transmits the updated system information. Upon receiving a change notification, the UE acquires the new system information from the start of the next modification period. The UE applies the previously acquired system information until the UE acquires the new system information.

System Information (SI) is divided into the MIB and a number of SIBs and posSIBs where:
# the MIB is always transmitted on the BCH with a periodicity of 80 ms and repetitions made within 80 ms (TS 38.212 [17], clause 7.1) and it includes parameters that are needed to acquire SIB1 from the cell. The first transmission of the MIB is scheduled in subframes as defined in TS 38.213 [13], clause 4.1 and repetitions are scheduled according to the period of SSB;
# the SIB1 is transmitted on the DL-SCH with a periodicity of 160 ms and variable transmission repetition periodicity within 160 ms. The default transmission repetition periodicity of SIB1 is 20 ms but the actual transmission repetition periodicity is up to network implementation. For SSB and CORESET multiplexing pattern 1, SIB1 repetition transmission period is 20 ms. For SSB and CORESET multiplexing pattern 2/3, SIB1 transmission repetition period is the same as the SSB period. SIB1 includes information regarding the availability and scheduling (e.g. mapping of SIBs to SI message, periodicity, SI-window size) of other SIBs with an indication whether one or more SIBs are only provided on-demand and, in that case, the configuration needed by the UE to perform the SI request. SIB1 is cell-specific SIB;
# SIBs other than SIB1 and posSIBs are carried in SystemInformation (SI) messages, which are transmitted on the DL-SCH. Only SIBs or posSIBs having the same periodicity can be mapped to the same SI message. SIBs and posSIBs are mapped to the different SI messages. Each SI message is transmitted within periodically occurring time domain windows (referred to as SI-windows with same length for all SI messages). Each SI message is associated with an SI-window and the SI-windows of different SI messages do not overlap. That is, within one SI-window only the corresponding SI message is transmitted. An SI message may be transmitted a number of times within the SI-window. Any SIB or posSIB except SIB1 can be configured to be cell specific or area specific, using an indication in SIB1. The cell specific SIB is applicable only within a cell that provides the SIB while the area specific SIB is applicable within an area referred to as SI area, which consists of one or several cells and is identified by systemInformationAreaID;
# The mapping of SIBs to SI messages is configured in schedulingInfoList and schedulingInfoList2, while the mapping of posSIBs to SI messages is configured in posSchedulingInfoList and schedulingInfoList2. SIBs and posSIBs are mapped to separate SI messages even when configured using a common schedulingInfoList2. Each SIB is contained only in a single SI message. In the case of posSIB, a posSIB carrying GNSS Generic Assistance Data for different GNSS/SBAS [49] is contained in different SI messages. Each SIB and posSIB, including a posSIB carrying GNSS Generic Assistance Data for one GNSS/SBAS, is contained at most once in that SI message;

The UE applies the SI acquisition procedure to acquire the AS, NAS- and positioning assistance data information. The procedure applies to UEs in RRC_IDLE, in RRC_INACTIVE and in RRC_CONNECTED.

The UE in RRC_IDLE and RRC_INACTIVE shall ensure having a valid version of (at least) the MIB, SIB1 through SIB4, SIB5 (if the UE supports E-UTRA), SIB11 (if the UE is configured for idle/inactive measurements), SIB12 (if UE is capable of NR sidelink communication/discovery and is configured by upper layers to receive or transmit NR sidelink communication/discovery), and SIB13, SIB14 (if UE is capable of V2X sidelink communication and is configured by upper layers to receive or transmit V2X sidelink communication), SIB15 (if UE is configured by upper layers to report disaster roaming related information), SIB16 (if the UE is capable of slice-based cell reselection and the UE receives NSAG information for cell reselection from upper layer), SIB17 (if the UE is using TRS resources for power saving in RRC_IDLE and RRC_INACTIVE) and SIB19 (if UE is accessing NR via NTN access).

The UE capable of MBS broadcast which is receiving or interested to receive MBS broadcast service(s) via a broadcast MRB shall ensure having a valid version of SIB20 and SIB21, regardless of the RRC state the UE is in.

The UE shall ensure having a valid version of the posSIB requested by upper layers.

The UE shall apply the SI acquisition procedure upon cell selection (e.g. upon power on), cell-reselection, return from out of coverage, after reconfiguration with sync completion, after entering the network from another RAT, upon receiving an indication that the system information has changed, upon receiving a PWS notification, upon receiving request (e.g., a positioning request) from upper layers; and whenever the UE does not have a valid version of a stored SIB or posSIB or a valid version of a requested SIB.

When the UE acquires a MIB or a SIB1 or an SI message in a serving cell, and if the UE stores the acquired SIB, then the UE shall store the associated areaScope, if present, the first PLMN-Identity in the PLMN-IdentityInfoList for non-NPN-only cells or the first NPN identity (SNPN identity in case of SNPN, or PNI-NPN identity in case of PNI-NPN) in the NPN-IdentityInfoList for NPN-only cells, the cellIdentity, the systemInformationAreaID, if present, and the valueTag, if present, as indicated in the si-SchedulingInfo for the SIB. If the UE stores the acquired posSIB, then the UE shall store the associated areaScope, if present, the cellIdentity, the systemInformationAreaID, if present, the valueTag, if provided in assistanceDataSIB-Element, and the expirationTime if provided in assistanceDataSIB-Element. The UE may use a valid stored version of the SI except MIB, SIB1, SIB6, SIB7 or SIB8 e.g. after cell re-selection, upon return from out of coverage or after the reception of SI change indication. The valueTag and expirationTime for posSIB is optionally provided in assistanceDataSIB-Element.

The UE shall:
# delete any stored version of a SIB after 3 hours from the moment it was successfully confirmed as valid;
# for each stored version of a SIB:
## if the areaScope is associated and its value for the stored version of the SIB is the same as the value received in the si-SchedulingInfo for that SIB from the serving cell:
### if the UE is NPN capable and the cell is an NPN-only cell:
#### if the first NPN identity included in the NPN-IdentityInfoList, the systemInformationAreaID and the valueTag that are included in the si-SchedulingInfo for the SIB received from the serving cell are identical to the NPN identity, the systemInformationAreaID and the valueTag associated with the stored version of that SIB:
##### consider the stored SIB as valid for the cell;
### else if the first PLMN-Identity included in the PLMN-IdentityInfoList, the systemInformationAreaID and the valueTag that are included in the si-SchedulingInfo for the SIB received from the serving cell are identical to the PLMN-Identity, the systemInformationAreaID and the valueTag associated with the stored version of that SIB:
#### consider the stored SIB as valid for the cell;
## if the areaScope is not present for the stored version of the SIB and the areaScope value is not included in the si-SchedulingInfo for that SIB from the serving cell:
### if the UE is NPN capable and the cell is an NPN-only cell:
#### if the first NPN identity in the NPN-IdentityInfoList, the cellIdentity and valueTag that are included in the si-SchedulingInfo for the SIB received from the serving cell are identical to the NPN identity, the cellIdentity and the valueTag associated with the stored version of that SIB:
##### consider the stored SIB as valid for the cell;
### else if the first PLMN-Identity in the PLMN-IdentityInfoList, the cellIdentity and valueTag that are included in the si-SchedulingInfo for the SIB received from the serving cell are identical to the PLMN-Identity, the cellIdentity and the valueTag associated with the stored version of that SIB:
#### consider the stored SIB as valid for the cell;
# for each stored version of a posSIB:
## if the areaScope is associated and its value for the stored version of the posSIB is the same as the value received in the posSIB-MappingInfo for that posSIB from the serving cell and the systemInformationAreaID included in the si-SchedulingInfo is identical to the systemInformationAreaID associated with the stored version of that posSIB:
### if the valueTag for the posSIB received from the serving cell is identical to the valueTag associated with the stored version of that posSIB; or if the expirationTime associated with the stored posSIB has not been expired:
#### consider the stored posSIB as valid for the cell;
## if the areaScope is not present for the stored version of the posSIB and the areaScope value is not included in the posSIB-MappingInfo for that posSIB from the serving cell and the cellIdentity for the posSIB received from the serving cell is identical to the cellIdentity associated with the stored version of that posSIB:
### if the valueTag for the posSIB received from the serving cell is identical to the valueTag associated with the stored version of that posSIB; or if the expirationTime associated with the stored posSIB has not been expired:
#### consider the stored posSIB as valid for the cell;

The UE shall, for acquisition of MIB and SIB1:
# apply the specified BCCH configuration;
# if the UE is in RRC_IDLE or in RRC_INACTIVE; or
# if the UE is in RRC_CONNECTED while T311 is running:
## acquire the MIB, which is scheduled;
## if the UE is unable to acquire the MIB;
### perform the actions as specified in clause essential_system_information_handling;
## else:
### perform the actions specified in clause MIB_reception_action.
# if the UE is in RRC_IDLE or in RRC_INACTIVE and if the concerned cell is not a SIB-less cell (type 2 cell):
## if ssb-SubcarrierOffset indicates SIB1 is transmitted in the cell and if SIB1 acquisition is required for the UE:
### acquire the SIB1, which is scheduled;
### if the UE is unable to acquire the SIB1:
#### perform the actions as specified in clause essential_system_information_handling;
### else:
#### upon acquiring SIB1, perform the actions specified in clause SIB1_reception_action SIB1_reception_action.
## else if SIB1 acquisition is required for the UE and ssb-SubcarrierOffset indicates that SIB1 is not scheduled in the cell:
### perform the actions as specified in clause essential_system_information_handling.
# else if the UE is in RRC_IDLE or in RRC_INACTIVE and if the concerned cell is a SIB-less cell (type 2 cell):
## if ssb-SubcarrierOffset indicates SIB1 is transmitted in the cell and if SIB1 acquisition is required for the UE:
3> perform SIB1 request procedure (MSI_request_procedure_type2_assisted_cell or MSI_request_procedure_type3_assisted_cell);
### acquire the SIB1;
### if the UE is unable to acquire the SIB1 after n consecutive SIB1 request procedure:
#### perform the actions as specified in clause essential_system_information_handling;
### else:
#### upon acquiring SIB1, perform the actions specified in clause SIB1_reception_action.
## else if SIB1 acquisition is required for the UE and ssb-SubcarrierOffset indicates that SIB1 is not scheduled in the cell:
### perform the actions as specified in clause essential_system_information_handling.

For SI message acquisition PDCCH monitoring occasion(s) are determined according to searchSpaceOtherSystemInformation. If searchSpaceOtherSystemInformation is set to zero, PDCCH monitoring occasions for SI message reception in SI-window are same as PDCCH monitoring occasions for SIB1. If searchSpaceOtherSystemInformation is not set to zero, PDCCH monitoring occasions for SI message are determined based on search space indicated by searchSpaceOtherSystemInformation. PDCCH monitoring occasions for SI message which are not overlapping with UL symbols (determined according to tdd-UL-DL-ConfigurationCommon) are sequentially numbered from one in the SI window. The [x×N+K]^{th} PDCCH monitoring occasion (s) for SI message in SI-window corresponds to the K^{th} transmitted SSB, where x=0, 1, . . . X−1, K=1, 2, . . . N, N is the number of actual transmitted SSBs determined according to ssb-PositionsInBurst in SIB1 and X is equal to CEIL (number of PDCCH monitoring occasions in SI-window/N). The actual transmitted SSBs are sequentially numbered from one in ascending order of their SSB indexes. The UE assumes that, in the SI window, PDCCH for an SI message is transmitted in at least one PDCCH monitoring occasion corresponding to each transmitted SSB and thus the selection of SSB for the reception SI messages is up to UE implementation.

When acquiring an SI message, the UE shall:
# determine the start of the SI-window for the concerned SI message as follows:
## if the concerned SI message is configured in the schedulingInfoList:
### for the concerned SI message, determine the number n which corresponds to the order of entry in the list of SI messages configured by schedulingInfoList in si-SchedulingInfo in SIB1;
### determine the integer value x=(n×1)×w, where w is the si-WindowLength;
### the SI-window starts at the slot #a, where a=x mod N, in the radio frame for which SFN mod T=FLOOR(x/N), where T is the si-Periodicity of the concerned SI message and N is the number of slots in a radio frame;
## else if the concerned SI message is configured in the schedulingInfoList2;
### determine the integer value x=(si-WindowPosition−1)×w, where w is the si-WindowLength;
### the SI-window starts at the slot #a, where a=x mod N, in the radio frame for which SFN mod T=FLOOR(x/N), where T is the si-Periodicity of the concerned SI message and N is the number of slots in a radio frame;
## else if the concerned SI message is configured in the posSchedulingInfoList and offsetToSI-Used is not configured:
### create a concatenated list of SI messages by appending the posSchedulingInfoList in posSI-SchedulingInfo in SIB1 to schedulingInfoList in si-SchedulingInfo in SIB1;
### for the concerned SI message, determine the number n which corresponds to the order of entry in the concatenated list;
### determine the integer value x=(n−1)×w, where w is the si-WindowLength;
### the SI-window starts at the slot #a, where a=x mod N, in the radio frame for which SFN mod T=FLOOR(x/N), where T is the posSI-Periodicity of the concerned SI message and N is the number of slots in a radio frame;
## else if the concerned SI message is configured by the posSchedulingInfoList and offsetToSI-Used is configured:
### determine the number m which corresponds to the number of SI messages with an associated si-Periodicity of 8 radio frames (80 ms), configured by schedulingInfoList in SIB1;
### for the concerned SI message, determine the number n which corresponds to the order of entry in the list of SI messages configured by posSchedulingInfoList in SIB1;
### determine the integer value x=m×w+(n−1)×w, where w is the si-WindowLength;
### the SI-window starts at the slot #a, where a=x mod N, in the radio frame for which SFN mod T=FLOOR(x/N)+8, where T is the posSI-Periodicity of the concerned SI message and N is the number of slots in a radio frame;
# receive the PDCCH containing the scheduling RNTI, i.e. SI-RNTI in the PDCCH monitoring occasion(s) for SI message acquisition, from the start of the SI-window and continue until the end of the SI-window whose absolute length in time is given by si-WindowLength, or until the SI message was received;
# if the SI message was not received by the end of the SI-window, repeat reception at the next SI-window occasion for the concerned SI message in the current modification period;
# if all the SIB(s) and/or posSIB(s) requested in DedicatedSIBRequest message have been acquired:
## stop timer T350, if running;
# perform the actions for the acquired SI message.

### <OSI Request Procedure>

The UE shall, while SDT procedure is not ongoing:
# if SIB1 includes si-SchedulingInfo containing si-RequestConfigSUL and criteria to select supplementary uplink is met:
## trigger the lower layer to initiate the Random Access procedure on supplementary uplink using the PRACH preamble(s) and PRACH resource(s) in si-RequestConfigSUL corresponding to the SI message(s) that the UE requires to operate within the cell, and for which si-BroadcastStatus is set to notBroadcasting;
## if acknowledgement for SI request is received from lower layers:
### acquire the requested SI message(s), immediately;
# else if the UE is a RedCap UE and if initialUplinkBWP-RedCap is configured in UplinkConfigCommonSIB and if SIB1 includes si-SchedulingInfo containing si-RequestConfigRedCap and criteria to select normal uplink is met:
## trigger the lower layer to initiate the Random Access procedure on normal uplink using the PRACH preamble(s) and PRACH resource(s) in si-RequestConfigRedcap corresponding to the SI message(s) that the UE requires to operate within the cell, and for which si-BroadcastStatus is set to notBroadcasting;
## if acknowledgement for SI request is received from lower layers:
### acquire the requested SI message(s) immediately;
# else:
## if the UE is not a RedCap UE and if SIB1 includes si-SchedulingInfo containing si-RequestConfig and criteria to select normal uplink is met; or
## if the UE is a RedCap UE and if initialUplinkBWP-RedCap is not configured in UplinkConfigCommonSIB and if SIB1 includes si-SchedulingInfo containing si-RequestConfig and criteria to select normal uplink is met:
### trigger the lower layer to initiate the Random Access procedure on normal uplink using the PRACH preamble(s) and PRACH resource(s) in si-RequestConfig corresponding to the SI message(s) that the UE requires to operate within the cell, and for which si-BroadcastStatus is set to notBroadcasting;
### if acknowledgement for SI request is received from lower layers:
#### acquire the requested SI message(s) immediately;
## else:
### apply the default L1 parameter values as specified in corresponding physical layer specifications except for the parameters for which values are provided in SIB1;
### apply the default MAC Cell Group configuration;
### apply the timeAlignmentTimerCommon included in SIB1;
### apply the CCCH configuration;
### initiate transmission of the RRCSystemInfoRequest message with rrcSystemInfoRequest;
### if acknowledgement for RRCSystemInfoRequest message with rrcSystemInfoRequest is received from lower layers:
#### acquire the requested SI message(s) immediately;
# if cell reselection occurs while waiting for the acknowledgment for SI request from lower layers:
## reset MAC;
## if SI request is based on RRCSystemInfoRequest message with rrcSystemInfoRequest:
### release RLC entity for SRB0.

### <MIB_Reception_Action Actions Upon Reception of the MIB>

Upon receiving the MIB the UE shall:
# store the acquired MIB;
# if the UE is in RRC_IDLE or in RRC_INACTIVE, or if the UE is in RRC_CONNECTED while T311 is running; and
# if the access is not for NTN or the UE is not capable of NTN:
## if the cellBarred in the acquired MIB is set to barred:
### if the UE is a RedCap UE and ssb-SubcarrierOffset indicates SIB1 is transmitted in the cell:
#### acquire the SIB1, which is scheduled;
### consider the cell as barred;
### perform cell re-selection to other cells on the same frequency as the barred cell;
## else:
### apply the received systemFrameNumber, pdcch-ConfigSIB1, subCarrierSpacingCommon, ssb-SubcarrierOffset and dmrs-TypeA-Position.

### <SIB1_Reception_Action Actions Upon Reception of the SIB1>

Upon receiving the SIB1 the UE shall:
# store the acquired SIB1;
# if the UE is a RedCap UE and it is in RRC_IDLE or in RRC_INACTIVE, or if the RedCap UE is in RRC_CONNECTED while T311 is running:
## if intraFreqReselectionRedCap is not present in SIB1:
### consider the cell as barred;
### perform barring as if intraFreqReselectionRedCap is set to allowed;
## else:
### if the cellBarredRedCap1Rx is present in the acquired SIB1 and is set to barred and the UE is equipped with 1 Rx branch; or
### if the cellBarredRedCap2Rx is present in the acquired SIB1 and is set to barred and the UE is equipped with 2 Rx branches; or
### if the halfDuplexRedCapAllowed is not present in the acquired SIB1 and the UE supports only half-duplex FDD operation:
#### consider the cell as barred;
#### perform barring based on intraFreqReselectionRedCap;
# if the cellAccessRelatedInfo contains an entry of a selected SNPN or PLMN and in case of PLMN the UE is either allowed or instructed to access the PLMN via a cell for which at least one CAG ID is broadcast:
## in the remainder of the procedures use npn-IdentityList, trackingAreaCode, and cellIdentity for the cell as received in the corresponding entry of npn-IdentityInfoList containing the selected PLMN or SNPN;
# else if the cellAccessRelatedInfo contains an entry with the PLMN-Identity of the selected PLMN:
## in the remainder of the procedures use plmn-IdentityList, trackingAreaCode, trackingAreaList, and cellIdentity for the cell as received in the corresponding PLMN-IdentityInfo containing the selected PLMN;
# if in RRC_CONNECTED while T311 is not running:
## disregard the frequencyBandList, if received, while in RRC_CONNECTED;
## forward the cellIdentity to upper layers;
## forward the trackingAreaCode to upper layers, if included;
## forward the trackingAreaList to upper layers, if included;
## forward the received posSIB-MappingInfo to upper layers, if included;
## apply the configuration included in the servingCellConfigCommon;
## if the UE has a stored valid version of a SIB or posSIB that the UE requires to operate within the cell:
### use the stored version of the required SIB or posSIB;
## else:
### acquire the required SIB or posSIB requested by upper layer;
# else:
## if the UE supports one or more of the frequency bands indicated in the frequencyBandList for downlink for TDD, or one or more of the frequency bands indicated in the frequencyBandList for uplink for FDD, and they are not downlink only bands, and
## if the UE is IAB-MT or supports at least one additionalSpectrumEmission in the NR-NS-PmaxList for a supported band in the downlink for TDD, or a supported band in uplink for FDD, and
## if the UE supports an uplink channel bandwidth with a maximum transmission bandwidth configuration which
### is smaller than or equal to the carrierBandwidth (indicated in uplinkConfigCommon for the SCS of the initial uplink BWP or, for RedCap UE, of the RedCap-specific initial uplink BWP if configured), and which
### is wider than or equal to the bandwidth of the initial uplink BWP or, for RedCap UE, of the RedCap-specific initial uplink BWP if configured, and
## if the UE supports a downlink channel bandwidth with a maximum transmission bandwidth configuration which
### is smaller than or equal to the carrierBandwidth (indicated in downlinkConfigCommon for the SCS of the initial downlink BWP or, for RedCap UE, of the RedCap-specific initial downlink BWP if configured), and which
### is wider than or equal to the bandwidth of the initial downlink BWP or, for RedCap UE, of the RedCap-specific initial downlink BWP if configured, and
## if frequencyShift7p5 khz is present and the UE supports corresponding 7.5 kHz frequency shift on this band; or frequencyShift7p5 khz is not present:
### if neither trackingAreaCode nor trackingAreaList is provided for the selected PLMN nor the registered PLMN nor PLMN of the equivalent PLMN list:
#### consider the cell as barred;
#### perform cell re-selection to other cells on the same frequency as the barred cell;
### else if UE is IAB-MT and if iab-Support is not provided for the selected PLMN nor the registered PLMN nor PLMN of the equivalent PLMN list nor the selected SNPN nor the registered SNPN:
#### consider the cell as barred;
### else:
#### apply a supported uplink channel bandwidth with a maximum transmission bandwidth which
##### is contained within the carrierBandwidth indicated in uplinkConfigCommon for the SCS of the initial uplink BWP or, for RedCap UEs, RedCap-specific initial uplink BWP, if configured, and which
##### is wider than or equal to the bandwidth of the initial BWP for the uplink or, for a RedCap UE, of the RedCap-specific initial uplink BWP if configured;
#### apply a supported downlink channel bandwidth with a maximum transmission bandwidth which
##### is contained within the carrierBandwidth indicated in downlinkConfigCommon for the SCS of the initial downlink BWP or, for RedCap UEs, RedCap-specific initial downlink BWP, if configured, and which
##### is wider than or equal to the bandwidth of the initial BWP for the downlink or, for a RedCap UE, of the RedCap-specific initial downlink BWP if configured;
#### select the first frequency band in the frequencyBandList, for FDD from frequencyBandList for uplink, or for TDD from frequencyBandList for downlink, which the UE supports and for which the UE supports at least one of the additionalSpectrumEmission values in nr-NS-PmaxList, if present;
#### forward the cell identity to upper layers;
#### forward the trackingAreaCode to upper layers;
#### forward the trackingAreaList to upper layers, if included;
#### forward the received posSIB-MappingInfo to upper layers, if included;
#### forward the PLMN identity or SNPN identity or PNI-NPN identity to upper layers;
#### if in RRC_INACTIVE and the forwarded information does not trigger message transmission by upper layers:
##### if the serving cell does not belong to the configured ran-NotificationAreaInfo:
###### initiate an RNA update as specified in 5.3.13.8;
#### forward the ims-EmergencySupport to upper layers, if present;
#### forward the eCallOverIMS-Support to upper layers, if present;
#### forward the UAC-AccessCategory1-SelectionAssistanceInfo or UAC-AC1-SelectAssistInfo for the selected PLMN/SNPN to upper layers, if present and set to a, b or c;
#### if the UE is in SNPN access mode:
##### forward the imsEmergencySupportForSNPN indicators with the corresponding SNPN identities to upper layers, if present;
#### apply the configuration included in the servingCellConfigCommon;
#### apply the specified PCCH configuration;
#### if the UE has a stored valid version of a SIB that the UE requires to operate within the cell:
##### use the stored version of the required SIB;
#### if the UE has not stored a valid version of a SIB of one or several required SIB(s),
##### for the SI message(s) that, according to the si-SchedulingInfo, contain at least one required SIB and for which si-BroadcastStatus is set to broadcasting:
###### acquire the SI message(s);
##### for the SI message(s) that, according to the si-SchedulingInfo, contain at least one required SIB and for which si-BroadcastStatus is set to notBroadcasting:
###### trigger a request to acquire the SI message(s);
#### if the UE has a stored valid version of a posSIB of one or several required posSIB(s),
##### use the stored version of the required posSIB;
#### if the UE has not stored a valid version of a posSIB of one or several posSIB(s):
##### for the SI message(s) that, according to the posSI-SchedulingInfo, contain at least one requested posSIB and for which posSI-BroadcastStatus is set to broadcasting:
###### acquire the SI message(s);
##### for the SI message(s) that, according to the posSI-SchedulingInfo, contain at least one requested posSIB for which posSI-BroadcastStatus is set to notBroadcasting:
###### trigger a request to acquire the SI message(s) a;
#### apply the first listed additionalSpectrumEmission which it supports among the values included in NR-NS-PmaxList within frequencyBandList in uplinkConfigCommon for FDD or in downlinkConfigCommon for TDD;
#### if the additionalPmax is present in the same entry of the selected additionalSpectrumEmission within NR-NS-PmaxList:
##### apply the additionalPmax for UL;
#### else:
##### apply the p-Max in uplinkConfigCommon for UL;
#### if supplementaryUplink is present in servingCellConfigCommon; and
#### if the UE supports one or more of the frequency bands indicated in the frequencyBandList for the supplementaryUplink; and
#### if the UE supports at least one additionalSpectrumEmission in the NR-NS-PmaxList for a supported supplementary uplink band; and
#### if the UE supports an uplink channel bandwidth with a maximum transmission bandwidth configuration (see TS 38.101-1 [15] and TS 38.101-2 [39]) which
##### is smaller than or equal to the carrierBandwidth (indicated in supplementaryUplink for the SCS of the initial uplink BWP), and which
##### is wider than or equal to the bandwidth of the initial uplink BWP of the SUL:
##### consider supplementary uplink as configured in the serving cell;
##### select the first frequency band in the frequencyBandList for the supplementaryUplink which the UE supports and for which the UE supports at least one of the additionalSpectrumEmission values in nr-NS-PmaxList, if present;
##### apply a supported supplementary uplink channel bandwidth with a maximum transmission bandwidth which
###### is contained within the carrierBandwidth (indicated in supplementaryUplink for the SCS of the initial uplink BWP), and which
###### is wider than or equal to the bandwidth of the initial BWP of the SUL;
##### apply the first listed additionalSpectrumEmission which it supports among the values included in NR-NS-PmaxList within frequencyBandList for the supplementaryUplink;
##### if the additionalPmax is present in the same entry of the selected additionalSpectrumEmission within NR-NS-PmaxList for the supplementaryUplink:
###### apply the additionalPmax in supplementaryUplink for SUL;
##### else:
###### apply the p-Max in supplementaryUplink for SUL;
## else:
### consider the cell as barred; and
### perform barring as if intraFreqReselection, or intraFreqReselectionRedCap for RedCap UEs, is set to notAllowed;

### <Essential_System_Information_Handling>

The UE shall:
# if in RRC_IDLE or in RRC_INACTIVE or in RRC_CONNECTED while T311 is running:
## if the UE is unable to acquire the MIB:
### consider the cell as barred;
### perform barring as if intraFreqReselection, or intraFreqReselectionRedCap for RedCap UEs, is set to allowed;
## else if the UE is unable to acquire the SIB1:
### consider the cell as barred;
### if the UE is a RedCap UE:
#### perform barring as if intraFreqReselectionRedCap is set to allowed;
### else:
#### perform cell re-selection to other cells on the same frequency as the barred cell.

Followings are ASN.1 codes of relevant message and IEs.

```
  -- ASN1START
  -- TAG-SIB1-START
  SIB1 ::= SEQUENCE {
```

| | |
|---|---|
| cellSelectionInfo | SEQUENCE { |
| q-RxLevMin | Q-RxLevMin, |
| q-RxLevMinOffset | INTEGER (1..8) |

OPTIONAL, -- Need S

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| q-QualMinOffset | INTEGER (1..8) |

OPTIONAL -- Need S
}
OPTIONAL, -- Cond Standalone

| | |
|---|---|
| cellAccessRelatedInfo | CellAccessRelatedInfo, |
| connEstFailureControl | ConnEstFailureControl |

OPTIONAL, -- Need R

| | |
|---|---|
| si-SchedulingInfo | SI-SchedulingInfo |

OPTIONAL, -- Need R

| | |
|---|---|
| servingCellConfigCommon | ServingCellConfigCommonSIB |

OPTIONAL, -- Need R

| | |
|---|---|
| ims-EmergencySupport | ENUMERATED {true} |

OPTIONAL, -- Need R

| | |
|---|---|
| eCallOverIMS-Support | ENUMERATED {true} |

OPTIONAL, -- Need R

| | |
|---|---|
| ue-TimersAndConstants | UE-TimersAndConstants |

OPTIONAL, -- Need R

| | |
|---|---|
| uac-BarringInfo | SEQUENCE { |
| uac-BarringForCommon | UAC-BarringPerCatList |

OPTIONAL, -- Need S

| | |
|---|---|
| uac-BarringPerPLMN-List | UAC-BarringPerPLMN-List |

OPTIONAL, -- Need S

| | |
|---|---|
| uac-BarringInfoSetList | UAC-BarringInfoSetList, |

uac-AccessCategory1-SelectionAssistanceInfo CHOICE {

| | |
|---|---|
| plmnCommon | UAC- |

AccessCategory1-SelectionAssistanceInfo,

| | |
|---|---|
| individualPLMNList | SEQUENCE (SIZE |

```
(2..maxPLMN)) OF UAC-AccessCategory1-SelectionAssistanceInfo
      }
OPTIONAL -- Need S
    }
OPTIONAL, -- Need R
```

| | |
|---|---|
| useFullResumeID | ENUMERATED {true} |

OPTIONAL, -- Need R

| | |
|---|---|
| lateNonCriticalExtension | OCTET STRING |

OPTIONAL,

| | |
|---|---|
| nonCriticalExtension | SIB1-v1610-IEs |

OPTIONAL
}

| | |
|---|---|
| si-SchedulingInfo-v1700 | SI-SchedulingInfo-v1700 |

OPTIONAL, -- Need R

| | |
|---|---|
| hyperSFN-r17 | BIT STRING (SIZE (10)) |

OPTIONAL, -- Need R

| | | |
|---|---|---|
| eDRX-AllowedIdle-r17 | ENUMERATED | {true} |

OPTIONAL, -- Need R

| | | |
|---|---|---|
| eDRX-AllowedInactive-r17 | ENUMERATED | {true} |

OPTIONAL, -- Cond EDRX-RC

| | |
|---|---|
| intraFreqReselectionRedCap-r17 | ENUMERATED {allowed, notAllowed} |

OPTIONAL, -- Need S

| | |
|---|---|
| cellBarredNTN-r17 | ENUMERATED {barred, notBarred} |

OPTIONAL, -- Need S

| | |
|---|---|
| nonCriticalExtension | SIB1-v1740-IEs |

OPTIONAL
}

| | |
|---|---|
| SIB1-v1740-IEs ::= | SEQUENCE { |
| si-SchedulingInfo-v1740 | SI-SchedulingInfo-v1740 |

OPTIONAL, -- Need R

| | |
|---|---|
| nonCriticalExtension | SEQUENCE { } |

OPTIONAL
}
-- TAG-SIB1-STOP
-- ASN1STOP

cellSelectionInfo: Parameters for cell selection related to the serving cell.

hyperSFN: Indicates hyper SFN which increments by one when the SFN wraps around. This field is excluded when determining changes in system information, i.e. changes of hyper SFN should not result in system information change notifications.

q-QualMin: Parameter “Qqualmin”, applicable for serving cell. If the field is absent, the UE applies the (default) value of negative infinity for Qqualmin.

q-QualMinOffset: Parameter “Qqualminoffset”. Actual value Qqualminoffset=field value [dB]. If the field is absent, the UE applies the (default) value of 0 dB for Qqualminoffset. Affects the minimum required quality level in the cell.

q-RxLevMin: Parameter “Qrxlevmin”, applicable for serving cell.

q-RxLevMinOffset: Parameter “Qrxlevminoffset”. Actual value Qrxlevminoffset=field value*2 [dB]. If absent, the UE applies the (default) value of 0 dB for Qrxlevminoffset. Affects the minimum required Rx level in the cell.

servingCellConfigCommon: Configuration of the serving cell.

```
  -- ASN1START
  -- TAG-SI-SCHEDULINGINFO-START
```

| | |
|---|---|
| SI-SchedulingInfo ::= | SEQUENCE { |
| schedulingInfoList | SEQUENCE (SIZE (1..maxSI- |

Message)) OF SchedulingInfo,

| | |
|---|---|
| si-WindowLength | ENUMERATED {s5, s10, s20, s40, |

s80, s160, s320, s640, s1280, s2560-v1710, s5120-v1710 },

| | |
|---|---|
| si-RequestConfig | SI-RequestConfig |

OPTIONAL, -- Cond MSG-1

| | |
|---|---|
| si-RequestConfigSUL | SI-RequestConfig |

OPTIONAL, -- Cond SUL-MSG-1

| | |
|---|---|
| systemInformationAreaID | BIT STRING (SIZE (24)) |

```
OPTIONAL, -- Need R
    ...
  }
```

| | |
|---|---|
| SchedulingInfo ::= | SEQUENCE { |
| si-BroadcastStatus | ENUMERATED {broadcasting, |

notBroadcasting},

| | |
|---|---|
| si-Periodicity | ENUMERATED {rf8, rf16, rf32, rf64, |

rf128, rf256, rf512},

| | |
|---|---|
| sib-MappingInfo | SIB-Mapping |

}

| | |
|---|---|
| SI-SchedulingInfo-v1700 ::= | SEQUENCE { |
| schedulingInfoList2-r17 | SEQUENCE (SIZE (1..maxSI- |

Message)) OF SchedulingInfo2-r17,

| | |
|---|---|
| dummy | SI-RequestConfig |

OPTIONAL
}

| | |
|---|---|
| SI-SchedulingInfo-v1740 ::= | SEQUENCE { |
| si-RequestConfigRedCap-r17 | SI-RequestConfig |

OPTIONAL -- Cond REDCAP-MSG-1
}

| | |
|---|---|
| SI-SchedulingInfo-v1800 ::= | SEQUENCE { |

| | |
|---|---|
| si-RequestConfigMSG1-Repetition-r18 | SI- |

| | |
|---|---|
| RequestConfigRepetition-r18 | OPTIONAL, -- Cond MSG-1 |

| | |
|---|---|
| si-RequestConfigRedCap-MSG1-Repetition-r18 | SI- |

| | |
|---|---|
| RequestConfigRepetition-r18 | OPTIONAL, -- Cond REDCAP- |

MSG-1

| | |
|---|---|
| si-RequestConfigSUL-MSG1-Repetition-r18 | SI- |

| | |
|---|---|
| RequestConfigRepetition-r18 | OPTIONAL -- Cond SUL- |

MSG-1
}

| | |
|---|---|
| SchedulingInfo2-r17 ::= | SEQUENCE { |
| si-BroadcastStatus-r17 | ENUMERATED {broadcasting, |

notBroadcasting},

| | |
|---|---|
| si-WindowPosition-r17 | INTEGER (1..256), |
| si-Periodicity-r17 | ENUMERATED {rf8, rf16, rf32, rf64, |

rf128, rf256, rf512},

| | |
|---|---|
| sib-MappingInfo-r17 | SIB-Mapping-v1700 |

}

| | |
|---|---|
| SIB-Mapping ::= | SEQUENCE (SIZE (1..maxSIB)) OF SIB- |

TypeInfo

| | |
|---|---|
| SIB-Mapping-v1700 ::= | SEQUENCE (SIZE (1..maxSIB)) OF |

SIB-TypeInfo-v1700

| | |
|---|---|
| SIB-TypeInfo ::= | SEQUENCE { |
| type | ENUMERATED {sibType2, |

sibType3, sibType4, sibType5, sibType6, sibType7, sibType8, sibType9,

sibType10-v1610,

sibType11-v1610, sibType12-v1610, sibType13-v1610,

sibType14-v1610,

spare3, spare2, spare1,... },

| | |
|---|---|
| valueTag | INTEGER (0..31) |

OPTIONAL, -- Cond SIB-TYPE

| | |
|---|---|
| areaScope | ENUMERATED {true} |

OPTIONAL -- Need S
}

| | |
|---|---|
| SIB-TypeInfo-v1700 ::= | SEQUENCE { |
| sibType-r17 | CHOICE { |
| type1-r17 | ENUMERATED {sibType15, |

sibType16, sibType17, sibType18, sibType19, sibType20, sibType21,

sibType22-

v1800, sibType23-v1800 ,sibType24-v1800, sibType25-v1800,

sibType17bis-

v1820, spare4, spare3, spare2, spare1,...},

| | |
|---|---|
| type2-r17 | SEQUENCE { |
| posSibType-r17 | ENUMERATED |

{posSibType1-9, posSibType1-10, posSibType2-24, posSibType2-25,
posSibType6-4, posSibType6-5, posSibType6-6, posSibType2-17a-v1770,
posSibType2-18a-v1770, posSibType2-20a-v1770, posSibType1-11-v1800,
posSibType1-12-v1800, posSibType2-26-v1800, posSibType2-27-v1800,
posSibType6-7-v1800, posSibType7-1-v1800,...,
posSibType7-2-v1800, posSibType7-3-v1800, posSibType7-4-v1800},

| | |
|---|---|
| encrypted-r17 | ENUMERATED { true } |

OPTIONAL, -- Need R

| | |
|---|---|
| gnss-id-r17 | GNSS-ID-r16 |

OPTIONAL, -- Need R

| | |
|---|---|
| sbas-id-r17 | SBAS-ID-r16 |

```
OPTIONAL -- Cond GNSS-ID-SBAS
      }
    },
```

| | |
|---|---|
| valueTag-r17 | INTEGER (0..31) |

OPTIONAL, -- Cond NonPosSIB

| | |
|---|---|
| areaScope-r17 | ENUMERATED {true} |

```
OPTIONAL -- Need S
  }
  -- TAG-SI-SCHEDULINGINFO-STOP
  -- ASN1STOP
```

areaScope: Indicates that a SIB is area specific. If the field is absent, the SIB is cell specific.

si-BroadcastStatus: Indicates if the SI message is being broadcasted or not. Change of si-BroadcastStatus should not result in system information change notifications in Short Message transmitted with P-RNTI over DCI.

si-Periodicity: Periodicity of the SI-message in radio frames. Value rf8 corresponds to 8 radio frames, value rf16 corresponds to 16 radio frames, and so on.

si-RequestConfig: Configuration of Msg1 resources that the UE uses for requesting SI-messages for which si-BroadcastStatus is set to notBroadcasting.

si-WindowLength: The length of the SI scheduling window. Value s5 corresponds to slots, value s10 corresponds to 10 slots and so on.

systemInformationAreaID: Indicates the system information area that the cell belongs to, if any. Any SIB with areaScope within the SI is considered to belong to this systemInformationAreaID. The systemInformationAreaID is unique within a PLMN/SNPN.

si-WindowPosition: This field indicates the SI window position of the associated SI-message. The network provides si-WindowPosition in an ascending order, i.e. si-WindowPosition in the subsequent entry in schedulingInfoList2 has always value higher than in the previous entry of schedulingInfoList2. The network configures this field in a way that ensures that SI messages scheduled by schedulingInfoList and/or posSchedulingInfoList do not overlap with SI messages scheduled by schedulingInfoList2.

sib-MappingInfo: Indicates which SIBs or posSIBs are contained in the SI message.

sibType: The type of SIB(s) mapped to SI for scheduling using schedulingInfoList2. Value type1 indicates SIBs and value type2 indicates posSIBs.

```
  -- ASN1START
  -- TAG-SIB2-START
```

| | |
|---|---|
| SIB2 ::= | SEQUENCE { |
| cellReselectionInfoCommon | SEQUENCE { |

| | |
|---|---|
| nrofSS-BlocksToAverage | INTEGER (2..maxNrofSS- |

| | | |
|---|---|---|
| BlocksToAverage) | OPTIONAL, | -- Need S |

| | |
|---|---|
| absThreshSS-BlocksConsolidation | ThresholdNR |

OPTIONAL, -- Need S

| | |
|---|---|
| rangeToBestCell | RangeToBestCell |

OPTIONAL, -- Need R

| q-Hyst | ENUMERATED { | |
|---|---|---|
| | | dB0, dB1, dB2, dB3, |

dB4, dB5, dB6, dB8, dB10,

dB12, dB14, dB16, dB18,

dB20, dB22, dB24},

| | |
|---|---|
| speedStateReselectionPars | SEQUENCE { |

| | |
|---|---|
| mobilityStateParameters | MobilityStateParameters, |

| | |
|---|---|
| q-HystSF | SEQUENCE { |

| | |
|---|---|
| sf-Medium | ENUMERATED {dB-6, |

dB-4, dB-2, dB0},

| | |
|---|---|
| sf-High | ENUMERATED {dB-6, |

```
dB-4, dB-2, dB0}
        }
      }
OPTIONAL, -- Need R
    ...
    },
```

| | |
|---|---|
| cellReselectionServingFreqInfo | SEQUENCE { |

| | |
|---|---|
| s-NonIntraSearchP | ReselectionThreshold |

OPTIONAL, -- Need S

| | |
|---|---|
| s-NonIntraSearchQ | ReselectionThresholdQ |

OPTIONAL, -- Need S

| | |
|---|---|
| threshServingLowP | ReselectionThreshold, |

| | |
|---|---|
| threshServingLowQ | ReselectionThresholdQ |

OPTIONAL, -- Need R

| | |
|---|---|
| cellReselectionPriority | CellReselectionPriority, |

| | |
|---|---|
| cellReselectionSubPriority | CellReselectionSubPriority |

```
OPTIONAL, -- Need R
      ...
    },
```

| | |
|---|---|
| intraFreqCellReselectionInfo | SEQUENCE { |

| | |
|---|---|
| q-RxLevMin | Q-RxLevMin, |
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| s-IntraSearchP | ReselectionThreshold, |

| | |
|---|---|
| s-IntraSearchQ | ReselectionThresholdQ |

OPTIONAL, -- Need S

| | |
|---|---|
| t-ReselectionNR | T-Reselection, |

| | |
|---|---|
| frequencyBandList | MultiFrequencyBandListNR- |

| | | |
|---|---|---|
| SIB | OPTIONAL, | -- Need S |

| | |
|---|---|
| frequencyBandListSUL | MultiFrequencyBandListNR- |

| | | |
|---|---|---|
| SIB | OPTIONAL, | -- Need R |

| | |
|---|---|
| p-Max | P-Max |

OPTIONAL, -- Need S

| | |
|---|---|
| smtc | SSB-MTC |

OPTIONAL, -- Need S

| | |
|---|---|
| ss-RSSI-Measurement | SS-RSSI-Measurement |

OPTIONAL, -- Need R

| | |
|---|---|
| ssb-ToMeasure | SSB-ToMeasure |

OPTIONAL, -- Need S

| | |
|---|---|
| deriveSSB-IndexFromCell | BOOLEAN, |

```
      ...,
      [[
```

| | |
|---|---|
| t-ReselectionNR-SF | SpeedStateScaleFactors |

```
OPTIONAL -- Need N
      ]],
      [[
```

| | |
|---|---|
| smtc2-LP-r16 | SSB-MTC2-LP-r16 |

OPTIONAL, -- Need R

| | |
|---|---|
| ssb-PositionQCL-Common-r16 | SSB-PositionQCL-Relation- |

| | | |
|---|---|---|
| r16 | OPTIONAL | -- Cond SharedSpectrum |

```
      ]],
      [[
```

| | |
|---|---|
| ssb-PositionQCL-Common-r17 | SSB-PositionQCL-Relation- |

| | | |
|---|---|---|
| r17 | OPTIONAL | -- Cond SharedSpectrum2 |

```
      ]],
      [[
```

| | |
|---|---|
| smtc4list-r17 | SSB-MTC4List-r17 |

```
OPTIONAL -- Need R
      ]]
    },
    ...,
```

| | |
|---|---|
| RangeToBestCell | ::= Q-OffsetRange |

```
  -- TAG-SIB2-STOP
  -- ASN1STOP
```

absThreshSS-BlocksConsolidation: Threshold for consolidation of L1 measurements per RS index. If the field is absent, the UE uses the measurement quantity as specified in TS 38.304 [20].

cellReselectionInfoCommon: Cell re-selection information common for intra-frequency, inter-frequency and/or inter-RAT cell re-selection.

cellReselectionServingFreqInfo: Information common for non-intra-frequency cell re-selection i.e. cell re-selection to inter-frequency and inter-RAT cells.

deriveSSB-IndexFromCell: This field indicates whether the UE can utilize serving cell timing to derive the index of SS block transmitted by neighbour cell. If this field is set to true, the UE assumes SFN and frame boundary alignment across cells on the serving frequency.

frequencyBandList: Indicates the list of frequency bands for which the NR cell reselection parameters apply.

intraFreqCellReselectionInfo: Cell re-selection information common for intra-frequency cells.

nrofSS-BlocksToAverage: Number of SS blocks to average for cell measurement derivation.

p-Max: Value in dBm applicable for the intra-frequency neighbouring NR cells.

q-Hyst: Parameter “Qhyst”, Value in dB. Value dB1 corresponds to 1 dB, dB2 corresponds to 2 dB and so on.

q-QualMin: Parameter “Qqualmin”, applicable for intra-frequency neighbour cells. If the field is absent, the UE applies the (default) value of negative infinity for Qqualmin.

q-RxLevMin: Parameter “Qrxlevmin”, applicable for intra-frequency neighbour cells. rangeToBestCell: Parameter “rangeToBestCell”.

s-IntraSearchP: Parameter “SIntraSearchP”.

s-IntraSearchQ: Parameter “SIntraSearchQ”. If the field is absent, the UE applies the (default) value of 0 dB for SIntraSearchQ.

s-NonIntraSearchP: Parameter “SnonIntraSearchP”. If this field is absent, the UE applies the (default) value of infinity for SnonIntraSearchP.

s-NonIntraSearchQ: Parameter “SnonIntraSearchQ”. If the field is absent, the UE applies the (default) value of 0 dB for SnonIntraSearchQ.

smtc: Measurement timing configuration for intra-frequency measurement. If this field is absent, the UE assumes that SSB periodicity is 5 ms for the intra-frequnecy cells.

ssb-ToMeasure: The set of SS blocks to be measured within the SMTC measurement duration When the field is absent the UE measures on all SS-blocks.

t-ReselectionNR: Parameter “TreselectionNR”.

threshServingLowP: Parameter “ThreshServing, LowP”.

threshServingLowQ: Parameter “ThreshServing, LowQ”.

```
  t-ReselectionNR: Parameter “TreselectionNR”.
  threshServingLowP: Parameter “ThreshServing, LowP”.
  threshServingLowQ: Parameter “ThreshServing, LowQ”.
  -- ASN1START
  -- TAG-SIB3-START
```

| | |
|---|---|
| SIB3 ::= | SEQUENCE { |
| intraFreqNeighCellList | IntraFreqNeighCellList |

OPTIONAL, -- Need R

| | |
|---|---|
| intraFreqExculdedCellList | IntraFreqExcudedCellList |

OPTIONAL, -- Need R

| | |
|---|---|
| lateNonCriticalExtension | OCTET STRING |

```
OPTIONAL,
    ...,
    [[
```

| | |
|---|---|
| intraFreqNeighCellList-v1610 | IntraFreqNeighCellList-v1610 |

OPTIONAL, -- Need R

| | |
|---|---|
| intraFreqAllowedCellList-v1610 | IntraFreqAllowedCellList-v1610 |

OPTIONAL, -- Cond SharedSpectum2

| | |
|---|---|
| intraFreqCAG-CellList-r16 | SEQUENCE (SIZE (1..maxPLMN)) |

| | |
|---|---|
| OF IntraFreqCAG-CellListPerPLMN-r16 | OPTIONAL -- Need R |

```
    ]],
    [[
```

| | |
|---|---|
| intraFreqNeighHSDN-CellList-r17 | IntraFreqNeighHSDN-CellList-r17 |

OPTIONAL, -- Need R

| | |
|---|---|
| intraFreqNeighCellList-v1710 | IntraFreqNeighCellList-v1710 |

```
OPTIONAL -- Need R
    ]],
    [[
```

| | |
|---|---|
| channelAccessMode2-r17 | ENUMERATED {enabled} |

```
OPTIONAL -- Need R
    ]],
  [[
```

| intra_Freq_type_2_cell_list | Intra_Freq_type_2_cell_list |
|---|---|
| | OPTIONAL -- Need R |
| intra_Freq_type_3_cell_list | Intra_Freq_type_3_cell_list |
| | OPTIONAL -- Need R |

```
  ]]
  }
```

| | |
|---|---|
| IntraFreqNeighCellList ::= | SEQUENCE (SIZE (1..maxCellIntra)) OF |

IntraFreqNeighCellInfo

| | |
|---|---|
| Intra_Freq_type_2_cell_list ::= | SEQUENCE (SIZE (1..maxCellIntra)) |

OF Intra_Freq_type_2_cell

| | |
|---|---|
| Intra_Freq_type_2_cell ::= | SEQUENCE { |
| physCellId | PhysCellId, |

```
  msi_Request_Id
  Intra_Freq_Msi_Request_Id
  ...
  }
```

| | |
|---|---|
| Intra_Freq_type_x_cell_list ::= | SEQUENCE (SIZE (1..maxCellIntra)) |

OF type_x_cell_info ///x is 2 or 3///
/// Type_x_cell_info comprises parameters for preliminary suitability check for cell
status and parameters relatd to MIB/SIB1 request configuration///

| | |
|---|---|
| type_x_cell_info ::= | SEQUENCE { |

| | |
|---|---|
| physCellId | PhysCellId, |

```
  msi_Request_Id
  Intra_Freq_Msi_Request_Id
  cellBarred /// present only in type 3 cell ///
```

| | |
|---|---|
| ntraFreqReselectionRedCap-r17 | ENUMERATED {allowed, notAllowed} |

OPTIONAL, -- Need S

| | |
|---|---|
| cellBarredNTN-r17 | ENUMERATED {barred, notBarred} |

OPTIONAL, -- Need S
cellBarredRedCap

| | |
|---|---|
| cellAccessRelatedInfo | CellAccessRelatedInfo (or any sub-IEs/sub-fields) |

Optional ///if this field present, cellAccessRelatedInfo indicates cell access related
information for this cell; if this field is absent, the same cellAccessRelatedInfo as indicated for
the serving cell (e.g. the cell where the system information is received) is cell access related
information for this cell///

| | |
|---|---|
| indication | ENUMERATED {Same} Optional |

```
///if this field present, CellAccessRelatedInfo (or any sub-IEs/fields in SIB1 is applied to this
cell as well///
  }
  -- TAG-SIB3-STOP
  -- ASN1STOP
```

intraFreqAllowedCellList: List of allow-listed intra-frequency neighbouring cells.

intraFreqExcludedCellList: List of exclude-listed intra-frequency neighbouring cells.

intraFreqNeighCellList: List of intra-frequency neighbouring cells with specific cell re-selection parameters.

q-OffsetCell: Parameter “Qoffsets,n”.

q-QualMinOffsetCell: Parameter “Qqualminoffsetcell”. Actual value Qqualminoffsetcell=field value [dB].

q-RxLevMinOffsetCell: Parameter “Qrxlevminoffsetcell”. Actual value Qrxlevminoffsetcell=field value*2 [dB].

ssb-PositionQCL: Indicates the QCL relation between SS/PBCH blocks for a specific intra-frequency neighbor cell. If provided, the cell specific value overwrites the value signalled by ssb-PositionQCL-Common in SIB2 for the indicated cell.

```
  -- ASN1START
  -- TAG-SIB4-START
```

| | |
|---|---|
| SIB4 ::= | SEQUENCE { |
| interFreqCarrierFreqList | InterFreqCarrierFreqList, |

| | |
|---|---|
| lateNonCriticalExtension | OCTET STRING |

```
OPTIONAL,
    ...,
    [[
```

| | |
|---|---|
| interFreqCarrierFreqList-v1610 | InterFreqCarrierFreqList-v1610 |

```
OPTIONAL -- Need R
    ]],
    [[
```

| | |
|---|---|
| interFreqCarrierFreqList-v1700 | InterFreqCarrierFreqList-v1700 |

```
OPTIONAL -- Need R
    ]],
    [[
```

| | |
|---|---|
| interFreqCarrierFreqList-v1720 | InterFreqCarrierFreqList-v1720 |

```
OPTIONAL -- Need R
    ]],
    [[
```

| | |
|---|---|
| interFreqCarrierFreqList-v1730 | InterFreqCarrierFreqList-v1730 |

```
OPTIONAL -- Need R
    ]],
    [[
```

| | |
|---|---|
| interFreqCarrierFreqList-v1760 | InterFreqCarrierFreqList-v1760 |

```
OPTIONAL -- Need R
    ]],
    [[
```

| | |
|---|---|
| interFreqCarrierFreqList-v18xy | InterFreqCarrierFreqList-v18xy |

```
OPTIONAL -- Need R
    ]],
  [[
```

| | |
|---|---|
| interFreqCarrierFreqList-v19xy | InterFreqCarrierFreqList-v19xy |

```
OPTIONAL -- Need R
    ]],
  }
```

| | |
|---|---|
| InterFreqCarrierFreqList ::= | SEQUENCE (SIZE (1..maxFreq)) OF |

InterFreqCarrierFreqInfo

| | |
|---|---|
| InterFreqCarrierFreqList-v19xy ::= | SEQUENCE (SIZE (1..maxFreq)) OF |

InterFreqCarrierFreqInfo-v19xy

| | |
|---|---|
| InterFreqCarrierFreqInfo ::= | SEQUENCE { |

| | |
|---|---|
| dl-CarrierFreq | ARFCN-ValueNR, |
| frequencyBandList | MultiFrequencyBandListNR-SIB |

OPTIONAL, -- Cond Mandatory

| | |
|---|---|
| frequencyBandListSUL | MultiFrequencyBandListNR-SIB |

OPTIONAL, -- Need R

| nrofSS-BlocksToAverage | | INTEGER (2..maxNrofSS- |
|---|---|---|
| BlocksToAverage) | OPTIONAL, | -- Need S |

| | |
|---|---|
| absThreshSS-BlocksConsolidation | ThresholdNR |

OPTIONAL, -- Need S

| | |
|---|---|
| smtc | SSB-MTC |

OPTIONAL, -- Need S

| | |
|---|---|
| ssbSubcarrierSpacing | SubcarrierSpacing, |

| | |
|---|---|
| ssb-ToMeasure | SSB-ToMeasure |

OPTIONAL, -- Need S

| | |
|---|---|
| deriveSSB-IndexFromCell | BOOLEAN, |

| | |
|---|---|
| ss-RSSI-Measurement | SS-RSSI-Measurement |

OPTIONAL, -- Need R

| | |
|---|---|
| q-RxLevMin | Q-RxLevMin, |

| | |
|---|---|
| q-RxLevMinSUL | Q-RxLevMin |

OPTIONAL, -- Need R

| | |
|---|---|
| q-QualMin | Q-QualMin |

OPTIONAL, -- Need S

| | |
|---|---|
| p-Max | P-Max |

OPTIONAL, -- Need S

| | |
|---|---|
| t-ReselectionNR | T-Reselection, |

| | |
|---|---|
| t-ReselectionNR-SF | SpeedStateScaleFactors |

OPTIONAL, -- Need S

| | |
|---|---|
| threshX-HighP | ReselectionThreshold, |
| threshX-LowP | ReselectionThreshold, |
| threshX-Q | SEQUENCE { |
| threshX-HighQ | ReselectionThresholdQ, |

| | |
|---|---|
| threshX-LowQ | ReselectionThresholdQ |

}
OPTIONAL, -- Cond RSRQ

| | |
|---|---|
| cellReselectionPriority | CellReselectionPriority |

OPTIONAL, -- Need R

| | |
|---|---|
| cellReselectionSubPriority | CellReselectionSubPriority |

OPTIONAL, -- Need R

| | |
|---|---|
| q-OffsetFreq | Q-OffsetRange |

DEFAULT dB0,

| | |
|---|---|
| interFreqNeighCellList | InterFreqNeighCellList |

OPTIONAL, -- Need R

| | |
|---|---|
| interFreqExcludedCellList | InterFreqExcludedCellList |

```
OPTIONAL, -- Need R
    ...
  }
```

| | |
|---|---|
| InterFreqCarrierFreqInfo-v1610 ::= | SEQUENCE { |

| | |
|---|---|
| interFreqNeighCellList-v1610 | InterFreqNeighCellList-v1610 |

OPTIONAL, -- Need R

| | |
|---|---|
| smtc2-LP-r16 | SSB-MTC2-LP-r16 |

OPTIONAL, -- Need R

| | |
|---|---|
| interFreqAllowedCellList-r16 | InterFreqAllowedCellList-r16 |

OPTIONAL, -- Cond SharedSpectrum2

| | |
|---|---|
| ssb-PositionQCL-Common-r16 | SSB-PositionQCL-Relation-r16 |

OPTIONAL, -- Cond SharedSpectrum

| | |
|---|---|
| interFreqCAG-CellList-r16 | SEQUENCE (SIZE (1..maxPLMN)) |

| | | |
|---|---|---|
| OF InterFreqCAG-CellListPerPLMN-r16 | OPTIONAL | -- Need R |

}

| | |
|---|---|
| InterFreqCarrierFreqInfo-v19xy ::= | SEQUENCE { |

| | |
|---|---|
| Inter_Freq_type_x_cell_list ::= | SEQUENCE (SIZE (1..maxCellIntra)) |

OF type_x_cell_info ///x is 2 or 3///
}

| | |
|---|---|
| InterFreqNeighCellList ::= | SEQUENCE (SIZE (1..maxCellInter)) OF |

InterFreqNeighCellInfo

| | |
|---|---|
| InterFreqNeighCellList-v1610 ::= | SEQUENCE (SIZE (1..maxCellInter)) OF |

InterFreqNeighCellInfo-v1610

| | |
|---|---|
| InterFreqNeighCellList-v1710 ::= | SEQUENCE (SIZE (1..maxCellInter)) OF |

InterFreqNeighCellInfo-v1710

| | |
|---|---|
| InterFreqNeighCellInfo ::= | SEQUENCE { |

| | |
|---|---|
| physCellId | PhysCellId, |
| q-OffsetCell | Q-OffsetRange, |

| | |
|---|---|
| q-RxLevMinOffsetCell | INTEGER (1..8) |

OPTIONAL, -- Need R

| | |
|---|---|
| q-RxLevMinOffsetCellSUL | INTEGER (1..8) |

OPTIONAL, -- Need R

| | |
|---|---|
| q-QualMinOffsetCell | INTEGER (1..8) |

```
OPTIONAL, -- Need R
    ...
  }
```

| | |
|---|---|
| InterFreqNeighCellInfo-v1610 ::= | SEQUENCE { |

| | |
|---|---|
| ssb-PositionQCL-r16 | SSB-PositionQCL-Relation-r16 |

OPTIONAL -- Cond SharedSpectrum2
}

| | |
|---|---|
| InterFreqExcludedCellList ::= | SEQUENCE (SIZE (1..maxCellExcluded)) OF |

PCI-Range

| | |
|---|---|
| InterFreqAllowedCellList-r16 ::= | SEQUENCE (SIZE (1..maxCellAllowed)) OF |

PCI-Range
InterFreqCAG-CellListPerPLMN-r16 ::= SEQUENCE {

| | |
|---|---|
| plmn-IdentityIndex-r16 | INTEGER (1..maxPLMN), |
| cag-CellList-r16 | SEQUENCE (SIZE (1..maxCAG-Cell- |

```
r16)) OF PCI-Range
  }
  -- TAG-SIB4-STOP
  -- ASN1STOP
```

SIB30 contains MSI request configuration information to assist cell reselection to a assisted cell for the UEs in an assisting cell.

```
  -- ASN1START
  -- TAG-SIBXX-START
  SIBXX-r18 ::= SEQUENCE {
```

| | |
|---|---|
| msi_Request_Config_List-r19 | Msi_Request_Config_List-r19 |

OPTIONAL, -- Need R

| | |
|---|---|
| lateNonCriticalExtension | OCTET STRING |

```
OPTIONAL,
    ...
  }
```

| | |
|---|---|
| Msi_Request_Config_List-r19 ::= | SEQUENCE (SIZE |

```
(1..maxMSI-RequestConfig-r19)) OF Msi_Request_Config-r19
  Msi_Request_Config-r19 ::= SEQUENCE {
    msi_request_id
  INTEGER(0..15),
```

| | |
|---|---|
| absoluteFrequencyPointA | ARFCN-ValueNR |

OPTIONAL,

| | |
|---|---|
| rach-OccasionsMSI | SEQUENCE { |
| rach-ConfigMSI | RACH-ConfigGeneric, |
| ssb-perRACH-Occasion | ENUMERATED {oneEighth, |

oneFourth, oneHalf, one, two, four, eight, sixteen}
}

| | |
|---|---|
| ra-PreambleIndex | INTEGER (0..63), |
| locationAndBandwidth | INTEGER (0..37949), /// related to uplink |

BWP; frequency resource for preamble transmission ///

| | |
|---|---|
| subcarrierSpacing | SubcarrierSpacing, |
| cyclicPrefix | ENUMERATED { extended } |

OPTIONAL -

| | |
|---|---|
| offsetToCarrier | INTEGER (0..2199), /// related to uplink |

BWP; frequency resource for preamble transmission ///
msi_reception_window ///For type 3, it indicates number of SSB bursts (or number of
selected SSB occasions that UE can try acquire MIB before UE performs preamble
retransmission) or length of time window for MIB/SIB1 reception. For type 2 (and type 3), it
indicates SSs that UE monitor to receive SIB 1 before UE performs preamble retransmission///

| | |
|---|---|
| ssb-PositionsInBurst | CHOICE { |

| | |
|---|---|
| shortBitmap | BIT STRING (SIZE (4)), |
| mediumBitmap | BIT STRING (SIZE (8)), |
| longBitmap | BIT STRING (SIZE (64)) |

}
OPTIONAL, -- Cond AbsFreqSSB

| | |
|---|---|
| ssb-periodicityServingCell | ENUMERATED { ms5, ms10, ms20, |

| | |
|---|---|
| ms40, ms80, ms160, spare2, spare1 } | OPTIONAL, -- Need S |

```
  }
  -- TAG-SIB30-STOP
  -- ASN1STOP
```

rach-OccasionsMSI: Configuration of dedicated RACH Occasions for MSI.

ssb-perRACH-Occasion: Number of SSBs per RACH occasion for MSI request.

offsetToCarrier: Offset in frequency domain between Point A (lowest subcarrier of common RB 0) and the lowest usable subcarrier on this carrier in number of PRBs (using the subcarrierSpacing defined for this carrier).

cyclicPrefix: Indicates whether to use the extended cyclic prefix for preamble transmission. If not set, the UE uses the normal cyclic prefix. Normal CP is supported for all subcarrier spacings and slot formats. Extended CP is supported only for 60 kHz subcarrier spacing.

locationAndBandwidth: Frequency domain location and bandwidth of this bandwidth part (for MSI request). The value of the field shall be interpreted as resource indicator value (RIV). The first PRB is a PRB determined by subcarrierSpacing and offsetToCarrier configured in this Msi_Request_Config

subcarrierSpacing: Subcarrier spacing to be used for MSI request for all channels and reference signals unless explicitly configured elsewhere.

The IE SI-RequestConfig contains configuration for Msg1 based SI request without Msg1 repetition.

```
  -- ASN1START
  -- TAG-SI-REQUESTCONFIG-START
```

| | |
|---|---|
| SI-RequestConfig ::= | SEQUENCE { |

| | |
|---|---|
| rach-OccasionsSI | SEQUENCE { |
| rach-ConfigSI | RACH-ConfigGeneric, |
| ssb-perRACH-Occasion | ENUMERATED {oneEighth, |

oneFourth, oneHalf, one, two, four, eight, sixteen}
}
OPTIONAL, -- Need R

| | |
|---|---|
| si-RequestPeriod | ENUMERATED {one, two, four, six, |

| | |
|---|---|
| eight, ten, twelve, sixteen} | OPTIONAL, -- Need R |

| | |
|---|---|
| si-RequestResources | SEQUENCE (SIZE (1..maxSI- |

Message)) OF SI-RequestResources
}

| | |
|---|---|
| SI-RequestResources ::= | SEQUENCE { |

| | |
|---|---|
| ra-PreambleStartIndex | INTEGER (0..63), |
| ra-AssociationPeriodIndex | INTEGER (0..15) |

OPTIONAL, -- Need R

| | |
|---|---|
| ra-ssb-OccasionMaskIndex | INTEGER (0..15) |

```
OPTIONAL -- Need R
  }
  -- TAG-SI-REQUESTCONFIG-STOP
  -- ASN1STOP
```

rach-OccasionsSL: Configuration of dedicated RACH Occasions for SI. If the field is absent, the UE uses the corresponding parameters configured in rach-ConfigCommon of the initial uplink BWP.

si-RequestPeriod: Periodicity of the SI-Request configuration in number of association periods.

si-RequestResources: If there is only one entry in the list, the configuration is used for all SI messages for which si-BroadcastStatus or posSI-BroadcastStatus is set to notBroadcasting. Otherwise: the 1st entry in the list corresponds to the first SI message in schedulingInfoList or posSchedulingInfoList for which si-BroadcastStatus or posSI-BroadcastStatus is set to notBroadcasting, 2nd entry in the list corresponds to the second SI message in schedulingInfoList or posSchedulingInfoList for which si-BroadcastStatus or posSI-BroadcastStatus is set to notBroadcasting and so on.

Change of si-RequestResources should not result in system information change notification.

The IE RACH-ConfigGeneric is used to specify the random-access parameters both for regular random access as well as for beam failure recovery.

```
  -- ASNISTART
  -- TAG-RACH-CONFIGGENERIC-START
```

| | |
|---|---|
| RACH-ConfigGeneric ::= | SEQUENCE { |
| prach-ConfigurationIndex | INTEGER (0..255), |
| msg1-FDM | ENUMERATED {one, two, four, |

eight},

| | |
|---|---|
| msg1-FrequencyStart | INTEGER |

(0..maxNrofPhysicalResourceBlocks-1),

| | |
|---|---|
| zeroCorrelationZoneConfig | INTEGER(0..15), |
| preambleReceivedTargetPower | INTEGER (−202..−60), |
| preambleTransMax | ENUMERATED {n3, n4, n5, n6, |

n7, n8, n10, n20, n50, n100, n200},

| | |
|---|---|
| powerRampingStep | ENUMERATED {dB0, dB2, dB4, |

dB6},

| | |
|---|---|
| ra-Response Window | ENUMERATED {sl1, sl2, sl4, sl8, |

```
sl10, sl20, sl40, sl80},
      ...,
    [[
```

| prach-ConfigurationPeriodScaling-IAB-r16 | | ENUMERATED |
|---|---|---|
| {scf1,scf2,scf4,scf8,scf16,scf32,scf64} | OPTIONAL, | -- Need R |

| | |
|---|---|
| prach-ConfigurationFrameOffset-IAB-r16 | INTEGER (0..63) |

OPTIONAL, -- Need R

| | |
|---|---|
| prach-ConfigurationSOffset-IAB-r16 | INTEGER (0..39) |

OPTIONAL, -- Need R

| | |
|---|---|
| ra-Response Window-v1610 | ENUMERATED { sl60, |

| | | |
|---|---|---|
| sl160} | OPTIONAL, | -- Need R |

| | |
|---|---|
| prach-ConfigurationIndex-v1610 | INTEGER (256..262) |

```
OPTIONAL -- Need R
    ]],
    [[
```

| | |
|---|---|
| ra-Response Window-v1700 | ENUMERATED {sl240, |
| sl320, sl640, sl960, sl1280, sl1920, sl2560} OPTIONAL | -- Need R |

```
    ]]
  }
  -- TAG-RACH-CONFIGGENERIC-STOP
  -- ASN1STOP
```

msg1-FrequencyStart: Offset of lowest PRACH transmission occasion in frequency domain with respective to PRB 0. The value is configured so that the corresponding RACH resource is entirely within the bandwidth of the UL BWP.

powerRampingStep: Power ramping steps for PRACH. This field is set to the same value for different repetition numbers associated with a specific FeatureCombination

prach-ConfigurationIndex: PRACH configuration index.

preambleReceivedTargetPower: The target power level at the network receiver side. Only multiples of 2 dBm may be chosen (e.g. −202, −200, −198, . . . ). This field is set to the same value for different repetition numbers associated with a specific FeatureCombination.

preambleTransMax: Max number of RA preamble transmission performed before declaring a failure.

```
  ra-Response Window: Msg2 (RAR) window length in number of slots.
  -- ASN1START
  -- TAG-BWP-START
```

| | |
|---|---|
| BWP ::= | SEQUENCE { |
| locationAndBandwidth | INTEGER (0..37949), |
| subcarrierSpacing | SubcarrierSpacing, |
| cyclicPrefix | ENUMERATED { extended } |

```
OPTIONAL -- Need R
  }
  -- TAG-BWP-STOP
  -- ASN1STOP
```

cyclicPrefix: Indicates whether to use the extended cyclic prefix for this bandwidth part. If not set, the UE uses the normal cyclic prefix. Normal CP is supported for all subcarrier spacings and slot formats.

locationAndBandwidth: Frequency domain location and bandwidth of this bandwidth part. The value of the field shall be interpreted as resource indicator value (RIV) The first PRB is a PRB determined by subcarrierSpacing of this BWP and offsetToCarrier corresponding to this subcarrier spacing. In case of TDD, a BWP-pair (UL BWP and DL BWP with the same bwp-Id) must have the same center frequency.

subcarrierSpacing: Subcarrier spacing to be used in this BWP for all channels and reference signals unless explicitly configured elsewhere. For the initial DL BWP and operation in licensed spectrum this field has the same value as the field subCarrierSpacingCommon in MIB of the same serving cell. Except for SUL, the network ensures the same subcarrier spacing is used in active DL BWP and active UL BWP within a serving cell. For the initial DL BWP and operation with shared spectrum channel access, the value of this field corresponds to the subcarrier spacing of the SSB associated to the initial DL BWP.

UE shall perform measurements for cell selection and reselection purposes.

In case that non-serving/target cell is type 0/1 cell, and in case of inter-frequency cell reselection:

When evaluating Srxlev and Squal of non-serving cells for reselection evaluation purposes, the UE shall use parameters provided by the serving cell and for the final check on cell selection criterion, the UE shall use parameters provided by the target cell for cell reselection.

parameters provided by the serving cell:
Q-RxLevMin & Q-QualMin in concerned InterFreqCarrierFreqInfo in SIB4 of the serving cell
parameters provided by the target cell
Q-RxLevMin & Q-QualMin in SIB2 of the target cell

In case that non-serving/target cell is type 2/3 cell, and in case of inter-frequency cell reselection:

When evaluating Srxlev and Squal of non-serving cells for reselection evaluation purposes, the UE shall use parameters provided by the serving cell and for the final check on cell selection criterion, the UE shall use parameters provided by the target cell for cell reselection.

parameters provided by the serving cell:
Q-RxLevMin & Q-QualMin in concerned InterFreqCarrierFreqInfo in SIB4 of the serving cell
parameters provided by the target cell
Q-RxLevMin & Q-QualMin in SIB2 of the target cell (SIB2 is acquired after SIB1 request)

The UE performs a first suitability check for a target cell based on acquired information from SIB4 of the serving cell, and performs a second suitability check (whether S-criteion is fulfilled or not) for the target cell based on acquired information of SIB2 which is received after MSI request and OSI request in the target cell
forbidden registration area(s) and a list of equivalent PLMNs. The UE shall select a suitable cell based on RRC_IDLE or RRC_INACTIVE state measurements and cell selection criteria.

In order to expedite the cell selection process, stored information for several RATs, if available, may be used by the UE.

When camped on a cell, the UE shall regularly search for a better cell according to the cell reselection criteria. If a better cell is found, that cell is selected. The change of cell may imply a change of RAT. Details on performance requirements for cell reselection can be found in TS 38.133 [8].

The NAS is informed if the cell selection and reselection result in changes in the received system information relevant for NAS.

For normal service, the UE shall camp on a suitable cell, monitor control channel(s) of that cell so that the UE can:
# receive system information from the PLMN or SNPN; and
## receive registration area information from the PLMN or SNPN, e.g., tracking area information; and
## receive other AS and NAS Information; and
# if registered:
## receive paging and notification messages from the PLMN or SNPN; and
## initiate transfer to Connected mode.

For cell selection in multi-beam operations, measurement quantity of a cell is up to UE implementation.

For cell reselection in multi-beam operations, including inter-RAT reselection from E-UTRA to NR, the measurement quantity of this cell is derived amongst the beams corresponding to the same cell based on SS/PBCH block as follows:
# if nrofSS-BlocksToAverage (maxRS-IndexCellQual in E-UTRA) is not configured in SIB2/SIB4 (SIB24 in E-UTRA); or
# if absThreshSS-BlocksConsolidation (threshRS-Index in E-UTRA) is not configured in SIB2/SIB4 (SIB24 in E-UTRA); or
# if the highest beam measurement quantity value is below or equal to absThreshSS-BlocksConsolidation (threshRS-Index in E-UTRA):
## derive a cell measurement quantity as the highest beam measurement quantity value, where each beam measurement quantity is described in TS 38.215 [11].
# else:
## derive a cell measurement quantity as the linear average of the power values of up to nrofSS-BlocksToAverage (maxRS-IndexCellQual in E-UTRA) of highest beam measurement quantity values above absThreshSS-BlocksConsolidation (threshRS-Index in E-UTRA).

The cell selection criterion S is fulfilled when:

Srxlev>0 AND Squal>0
where:

Srxlev=Qrxlevmeas−(Qrxlevmin+Qrxlevminoffset)−Pcompensation−Qoffsettemp

Squal=Qqualmeas−(Qqualmin+Qqualminoffset)−Qoffsettemp
where:
Srxlev: Cell selection RX level value (dB)
Squal: Cell selection quality value (dB)
Qoffsettemp: Offset temporarily applied to a cell as specified in TS 38.331 [3](dB)
Qrxlevmeas: Measured cell RX level value (RSRP)
Qqualmeas: Measured cell quality value (RSRQ)
Qrxlevmin: Minimum required RX level in the cell (dBm). Qrxlevmin is obtained from q-RxLevMin in SIB1, SIB2 and SIB4, additionally, if Qrxlevminoffsetcell is present in SIB3 and SIB4 for the concerned cell, this cell specific offset is added to the corresponding Qrxlevmin to achieve the required minimum RX level in the concerned cell.
Qqualmin: Minimum required quality level in the cell (dB). Additionally, if Qqualminoffsetcell is signalled for the concerned cell, this cell specific offset is added to achieve the required minimum quality level in the concerned cell.
Qrxlevminoffset: Offset to the signalled Qrxlevmin taken into account in the Srxlev evaluation as a result of a periodic search for a higher priority PLMN while camped normally in a VPLMN.

Qqualminoffset Offset to the signalled Qqualmin taken into account in the Squal evaluation as a result of a periodic search for a higher priority PLMN while camped normally in a VPLMN.

Absolute priorities of different NR frequencies or inter-RAT frequencies may be provided to the UE in the system information, in the RRCRelease message, or by inheriting from another RAT at inter-RAT cell (re)selection. In the case of system information, an NR frequency or inter-RAT frequency may be listed without providing a priority (i.e. the field cellReselectionPriority is absent for that frequency). If any fields with cellReselectionPriority or nsag-CellReselectionPriority are provided in dedicated signalling, the UE shall ignore any fields with cellReselectionPriority and nsag-CellReselectionPriority provided in system information.

When UE is in camped normally state, if it supports slice-based cell reselection and has received the network slice(s) and NSAG information from NAS to be used for cell reselection, UE shall derive reselection priorities.

If UE is in camped on any cell state, UE shall only apply the priorities provided by system information from current cell, and the UE preserves priorities provided by dedicated signalling and deprioritisationReq received in RRCRelease unless specified otherwise. When the UE in camped normally state, has only dedicated priorities other than for the current frequency, the UE shall consider the current frequency to be the lowest priority frequency (i.e. lower than any of the network configured values).

The UE shall only perform cell reselection evaluation for NR frequencies and inter-RAT frequencies that are given in system information and for which the UE has a priority provided.

If the MBS broadcast capable UE is receiving or interested to receive an MBS broadcast service(s) and can only receive this MBS broadcast service(s) by camping on a frequency on which it is provided, the UE may consider that frequency to be the highest priority during the MBS broadcast session as specified in TS 38.300 [2] as long as the two following conditions are fulfilled:
# SIB1 scheduling information of the cell reselected by the UE due to frequency prioritization for MBS contains SIB20;
# Either:
## one or more MBS FSAI(s) of that frequency is indicated in SIB21 of the serving cell and the same MBS FSAI(s) is also indicated for this MBS broadcast service in MBS User Service Description (USD) as specified in TS 26.346 [20], or
## SIB21 is not provided in the serving cell and that frequency is included in the USD of this service, or
## SIB21 is provided in the serving cell but does not provide the frequency mapping for the concerned service, and that frequency is included in the USD of this service.

In case UE receives RRCRelease with deprioritisationReq, UE shall consider current frequency and stored frequencies due to the previously received RRCRelease with deprioritisationReq or all the frequencies of NR to be the lowest priority frequency (i.e. lower than any of the network configured values) while T325 is running irrespective of camped RAT. The UE shall delete the stored deprioritisation request(s) when a PLMN selection or SNPN selection is performed on request by NAS.

The UE shall delete priorities provided by dedicated signalling when:
# the UE enters a different RRC state; or
# the optional validity time of dedicated priorities (T320) expires; or
# the UE receives an RRCRelease message with the field cellReselectionPriorities absent; or
# a PLMN selection or SNPN selection is performed on request by NAS.

The UE shall not consider any exclude-listed cells as candidate for cell reselection.

The UE shall consider only the allow-listed cells, if configured, as candidates for cell reselection.

The UE in RRC_IDLE state shall inherit the priorities provided by dedicated signalling and the remaining validity time (i.e. T320 in NR and E-UTRA), if configured, at inter-RAT cell (re)selection.

Following rules are used by the UE to limit needed measurements:
# If the serving cell fulfils Srxlev>SIntraSearchP and Squal>SIntrasearehQ:
## If distanceThresh and referenceLocation are broadcasted in SIB19, and if UE supports location-based measurement initiation and has obtained its location information:
### If the distance between UE and the serving cell reference location referenceLocation is shorter than distanceThresh, the UE may not perform intra-frequency measurements;
### Else, the UE shall perform intra-frequency measurements;
## Else, the UE may not perform intra-frequency measurements;
# Else, the UE shall perform intra-frequency measurements.
# The UE shall apply the following rules for NR inter-frequencies and inter-RAT frequencies which are indicated in system information and for which the UE has priority provided:
## For a NR inter-frequency or inter-RAT frequency with a reselection priority higher than the reselection priority of the current NR frequency, the UE shall perform measurements of higher priority NR inter-frequency or inter-RAT frequencies.
## For a NR inter-frequency with an equal or lower reselection priority than the reselection priority of the current NR frequency and for inter-RAT frequency with lower reselection priority than the reselection priority of the current NR frequency:
### If the serving cell fulfils Srxlev>S_{nonIntraSearchP} and Squal >S_{nonIntraSearchQ}:
#### If distanceThresh and referenceLocation are broadcasted in SIB19, and if UE supports location-based measurement initiation and has obtained its UE location information:
##### If the distance between UE and the serving cell reference location referenceLocation is shorter than distanceThresh, the UE may choose not to perform measurements of NR inter-frequency cells of equal or lower priority, or inter-RAT frequency cells of lower priority;
##### Else, the UE shall perform measurements of NR inter-frequency cells of equal or lower priority, or inter-RAT frequency cells of lower priority;
#### Else, the UE may choose not to perform measurements of NR inter-frequency cells of equal or lower priority, or inter-RAT frequency cells of lower priority;
### Else, the UE shall perform measurements of NR inter-frequency cells of equal or lower priority, or inter-RAT frequency cells of lower priority.
# If the UE supports relaxed measurement and relaxedMeasurement is present in SIB2, the UE may further relax the needed measurements.

If the t-Service of the serving cell is present in SIB19, and if UE supports time-based measurement initiation, the UE shall perform intra-frequency, inter-frequency or inter-RAT measurements before the t-Service, regardless of the distance between UE and the serving cell reference location or whether the serving cell fulfils Srxlev>S_{IntraSearchP} and Squal>S_{IntrasearchQ}, or Srxlev>S_{nonIntraSearchP} and Squal>S_{nonIntrasearchQ}, The exact time to start measurement before t-Service is up to UE implementation. UE shall perform measurements of higher priority NR inter-frequency or inter-RAT frequencies regardless of the remaining service time of the serving cell (i.e. time remaining until t-Service).

If threshServingLowQ is broadcast in system information and more than 1 second has elapsed since the UE camped on the current serving cell, cell reselection to a cell on a higher priority NR frequency or inter-RAT frequency than the serving frequency shall be performed if:
# A cell of a higher priority NR or EUTRAN RAT/frequency fulfils Squal>Thresh_{X, HighQ} during a time interval Treselection_{RAT}

Otherwise, cell reselection to a cell on a higher priority NR frequency or inter-RAT frequency than the serving frequency shall be performed if:
# A cell of a higher priority RAT/frequency fulfils Srxlev>Thresh_{X, HighP} during a time interval Treselection_{RAT}; and
# More than 1 second has elapsed since the UE camped on the current serving cell.

Cell reselection to a cell on an equal priority NR frequency shall be based on ranking for intra-frequency cell reselection.

If threshServingLowQ is broadcast in system information and more than 1 second has elapsed since the UE camped on the current serving cell, cell reselection to a cell on a lower priority NR frequency or inter-RAT frequency than the serving frequency shall be performed if:
# The serving cell fulfils Squal<Thresh_{serving, LowQ} and a cell of a lower priority NR or E-UTRAN RAT/frequency fulfils Squal>Thresh_{X, LowQ} during a time interval Treselection_{RAT}.

Otherwise, cell reselection to a cell on a lower priority NR frequency or inter-RAT frequency than the serving frequency shall be performed if:
# The serving cell fulfils Srxlev<Thresh_{serving, LowP} and a cell of a lower priority RAT/frequency fulfils Srxlev>Thresh_{X, LowP} during a time interval Treselection_{RAT}; and
# More than 1 second has elapsed since the UE camped on the current serving cell.

Cell reselection to a higher priority RAT/frequency shall take precedence over a lower priority RAT/frequency if multiple cells of different priorities fulfil the cell reselection criteria.

If more than one cell meets the above criteria, the UE shall reselect a cell as follows:
# If the highest-priority frequency is an NR frequency, the highest ranked cell among the cells on the highest priority frequency(ies) meeting the criteria;
# If the highest-priority frequency is from another RAT, the strongest cell among the cells on the highest priority frequency(ies) meeting the criteria of that RAT.

The cell-ranking criterion Rₛ for serving cell and Rₙ for neighbouring cells is defined by:

$${R}_{s} = {Q}_{meas , s} + {Q}_{hyst} - {Qoffset}_{temp}$$

$${R}_{n} = {Q}_{meas , n} - Qoffset - {Qoffset}_{temp}$$

where:

Qmeas: RSRP measurement quantity used in cell reselections.

Qoffset: For intra-frequency: Equals to Qoffsets,n, if Qoffsets,n is valid, otherwise this equals to zero.

For inter-frequency: Equals to Qoffsets,n plus Qoffsetfrequency, if Qoffsets,n is valid, otherwise this equals to Qoffsetfrequency.

Qoffsettemp: Offset temporarily applied to a cell.

The UE shall perform ranking of all cells that fulfil the cell selection criterion S.

The cells shall be ranked according to the R criteria specified above by deriving Q_{meas,n} and Q_{meas,s} and calculating the R values using averaged RSRP results.

If rangeToBestCell is not configured, the UE shall perform cell reselection to the highest ranked cell. If this cell is found to be not-suitable, the UE consider the cell barred.

If rangeToBestCell is configured, then the UE shall perform cell reselection to the cell with the highest number of beams above the threshold (i.e. absThreshSS-BlocksConsolidation) among the cells whose R value is within rangeToBestCell of the R value of the highest ranked cell. If there are multiple such cells, the UE shall perform cell reselection to the highest ranked cell among them. If this cell is found to be not-suitable, the UE the UE consider the cell barred.

In all cases, the UE shall reselect the new cell, only if the following conditions are met:
# the new cell is better than the serving cell according to the cell reselection criteria specified above during a time interval Treselection_{RAT};
# more than 1 second has elapsed since the UE camped on the current serving cell.

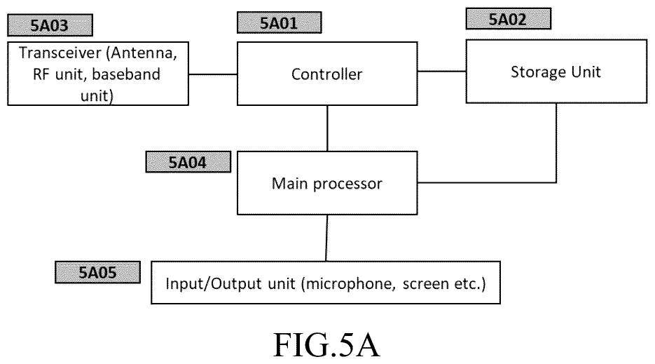

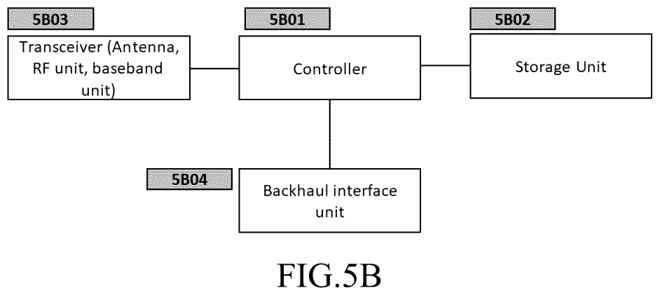

FIG. 5A is a block diagram illustrating the internal structure of a Terminal to which the disclosure is applied.

Referring to the diagram, the terminal includes a controller (5A01), a storage unit (5A02), a transceiver (5A03), a main processor (5A04) and I/O unit (5A05).

The controller (5A01) controls the overall operations of the terminal in terms of mobile communication. For example, the controller (5A01) receives/transmits signals through the transceiver (5A03). In addition, the controller (5A01) records and reads data in the storage unit (5A02). To this end, the controller (5A01) includes at least one processor. For example, the controller (5A01) may include a communication processor (CP) that performs control for communication and an application processor (AP) that controls the upper layer, such as an application program. The controller controls storage unit and transceiver such that UE operations illustrated in this disclosure are performed.

The storage unit (5A02) stores data for operation of the terminal, such as a basic program, an application program, and configuration information. The storage unit (5A02) provides stored data at a request of the controller (5A01).

The transceiver (5A03) consists of a RF processor, a baseband processor and plurality of antennas. The RF processor performs functions for transmitting/receiving signals through a wireless channel, such as signal band conversion, amplification, and the like. Specifically, the RF processor up—converts a baseband signal provided from the baseband processor into an RF band signal, transmits the same through an antenna, and down—converts an RF band signal received through the antenna into a baseband signal. The RF processor may include a transmission filter, a reception filter, an amplifier, a mi10r, an oscillator, a digital-to-analog converter (DAC), an analog-to-digital converter (ADC), and the like. The RF processor may perform MIMO and may receive multiple layers when performing the MIMO operation. The baseband processor performs a function of conversion between a baseband signal and a bit string according to the physical layer specification of the system. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The main processor (5A04) controls the overall operations other than mobile operation. The main processor (5A04) process user input received from I/O unit (5A05), stores data in the storage unit (5A02), controls the controller (5A01) for required mobile communication operations and forward user data to I/O unit (5A05).

I/O unit (5A05) consists of equipment for inputting user data and for outputting user data such as a microphone and a screen. I/O unit (5A05) performs inputting and outputting user data based on the main processor's instruction.

FIG. 5B is a block diagram illustrating the configuration of a base station according to the disclosure.

As illustrated in the diagram, the base station includes a controller (5B01), a storage unit (5B02), a transceiver (5B03) and a backhaul interface unit (5B04).

The controller (5B01) controls the overall operations of the main base station. For example, the controller (5B01) receives/transmits signals through the transceiver (5B03), or through the backhaul interface unit (5B04). In addition, the controller (5B01) records and reads data in the storage unit (5B02). To this end, the controller (5B01) may include at least one processor. The controller controls transceiver, storage unit and backhaul interface such that base station operation illustrated in this disclosure are performed.

The storage unit (5B02) stores data for operation of the main base station, such as a basic program, an application program, and configuration information. Particularly, the storage unit (5B02) may store information regarding a bearer allocated to an accessed UE, a measurement result reported from the accessed UE, and the like. In addition, the storage unit (5B02) may store information serving as a criterion to deter mine whether to provide the terminal with multi-connection or to discontinue the same. In addition, the storage unit (5B02) provides stored data at a request of the controller (5B01).

The transceiver (5B03) consists of a RF processor, a baseband processor and plurality of antennas. The RF processor performs functions for transmitting/receiving signals through a wireless channel, such as signal band conversion, amplification, and the like. Specifically, the RF processor up-converts a baseband signal provided from the baseband processor into an RF band signal, transmits the same through an antenna, and down-converts an RF band signal received through the antenna into a baseband signal. The RF processor may include a transmission filter, a reception filter, an amplifier, a mi10r, an oscillator, a DAC, an ADC, and the like. The RF processor may perform a down link MIMO operation by transmitting at least one layer. The baseband processor performs a function of conversion between a baseband signal and a bit string according to the physical layer specification of the first radio access technology. For example, during data transmission, the baseband processor encodes and modulates a transmission bit string, thereby generating complex symbols. In addition, during data reception, the baseband processor demodulates and decodes a baseband signal provided from the RF processor, thereby restoring a reception bit string.

The backhaul interface unit (5B04) provides an interface for communicating with other nodes inside the network. The backhaul interface unit (5B04) converts a bit string transmitted from the base station to another node, for example, another base station or a core network, into a physical signal, and converts a physical signal received from the other node into a bit string.

Below lists acronym used in the present disclosure.

| | |
|---|---|
| 5GC | 5G Core Network |
| ACK | Acknowledgement |
| AM | Acknowledged Mode |
| AMF | Access and Mobility Management Function |
| ARQ | Automatic Repeat Request |
| AS | Access Stratum |
| ASN.1 | Abstract Syntax Notation One |
| BSR | Buffer Status Report |
| BWP | Bandwidth Part |
| CA | Carrier Aggregation |
| CAG | Closed Access Group |
| CG | Cell Group |
| C-RNTI | Cell RNTI |
| CSI | Channel State Information |
| DCI | Downlink Control Information |
| DRB | (user) Data Radio Bearer |
| DTX | Discontinuous Reception |
| HARQ | Hybrid Automatic Repeat Request |
| IE | Information element |
| LCG | Logical Channel Group |
| MAC | Medium Access Control |
| MIB | Master Information Block |
| NAS | Non-Access Stratum |
| NG-RAN | NG Radio Access Network |
| NR | NR Radio Access |
| PBR | Prioritised Bit Rate |
| PCell | Primary Cell |
| PCI | Physical Cell Identifier |
| PDCCH | Physical Downlink Control Channel |
| PDCP | Packet Data Convergence Protocol |
| PDSCH | Physical Downlink Shared Channel |
| PDU | Protocol Data Unit |
| PHR | Power Headroom Report |
| PLMN | Public Land Mobile Network |
| PRACH | Physical Random Access Channel |
| CRP | Cell Reselection Priority |
| PRB | Physical Resource Block |
| PSS | Primary Synchronisation Signal |
| PUCCH | Physical Uplink Control Channel |
| PUSCH | Physical Uplink Shared Channel |
| RACH | Random Access Channel |
| RAN | Radio Access Network |
| RAR | Random Access Response |
| RA-RNTI | Random Access RNTI |
| RAT | Radio Access Technology |
| RB | Radio Bearer |
| RLC | Radio Link Control |
| RNA | RAN-based Notification Area |
| RNAU | RAN-based Notification Area Update |
| RNTI | Radio Network Temporary Identifier |
| RRC | Radio Resource Control |
| RRM | Radio Resource Management |
| RSRP | Reference Signal Received Power |
| RSRQ | Reference Signal Received Quality |
| RSSI | Received Signal Strength Indicator |
| SCell | Secondary Cell |
| SCS | Subcarrier Spacing |
| SDAP | Service Data Adaptation Protocol |
| SDU | Service Data Unit |
| SFN | System Frame Number |
| S-GW | Serving Gateway |
| SI | System Information |
| SIB | System Information Block |
| SpCell | Special Cell |
| SRB | Signalling Radio Bearer |
| SRS | Sounding Reference Signal |
| SS | Search Space |
| SSB | SS/PBCH block |
| SSS | Secondary Synchronisation Signal |
| SUL | Supplementary Uplink |
| TM | Transparent Mode |
| UCI | Uplink Control Information |
| UE | User Equipment |
| UM | Unacknowledged Mode |

What is claimed is:

1. A method performed by a terminal, the method comprising:
receiving by the terminal in a first cell a synchronization signal physical broadcast channel block (SSB); and
performing by the terminal in the first cell a procedure for system information acquisition,
wherein the SSB comprises:
a primary synchronization signal;
a secondary synchronization signal; and
a transport block,
wherein the transport block comprises:
a first set of bits corresponding to master information block; and
a second set of bits appended to the first set of bits,
wherein an index value is determined based on:
a specific bit in the second set of bits; and
a specific field of the master information block,
wherein a first procedure is performed for system information acquisition in case that:
a frequency band of the first cell belongs to a first frequency region; and
the index value is equal to a first specific value,
wherein a second procedure is performed for system information acquisition in case that:
the frequency band of the first cell belongs to a first frequency region;
the index value is within a first range; and
a scheduling information of a second system information indicates that the second system information is not broadcasting,
wherein:
the first procedure is to request a first system information; and
the second procedure is to request the second system information, and
wherein:
the first system information comprises the scheduling information of the second system information; and
the second system information comprises one or more system information blocks.

2. The method of claim 1, wherein:
the first procedure is performed in case that:
the frequency band of the first cell belongs to a second frequency region; and
the index value is equal to a second specific value, and
the second procedure is performed in case that:
the frequency band of the first cell belongs to the second frequency region;
the index value is within a second range; and
the scheduling information of the second system information indicates that the second system information is not broadcasting.

3. The method of claim 2,
wherein one or more random access preambles are transmitted in the first cell based on:
a set of random access resource parameters comprised in a third system information in a second cell in case that the first procedure is performed; and
a set of random access resource parameters comprised in the first system information in the first cell in case that the second procedure is performed.

4. The method of claim 3, wherein the first system information is acquired:
after the one or more random access preambles are transmitted in case that:
the frequency band of the first cell belongs to the first frequency region; and
the index value is equal to the first specific value, and
before the one or more random access preambles are transmitted in case that:
the frequency band of the first cell belongs to the first frequency region; and
the index value is within the first range.

5. The method of claim 4, wherein the first system information is acquired:
after the one or more random access preambles are transmitted in case that:
the frequency band of the first cell belongs to the second frequency region; and
the index value is equal to the second specific value, and
before the one or more random access preambles are transmitted in case that:
the frequency band of the first cell belongs to the second frequency region; and
the index value is within the second range.

6. The method of claim 5, wherein a second specific field of the master information block is applied:
after the first procedure is started in case that:
the frequency band of the first cell belongs to the second frequency region; and
the index value is equal to the second specific value, and
before the second procedure is started in case that:
the frequency band of the first cell belongs to the second frequency region; and
the index value is within the second range.

7. The method of claim 6,
wherein the second specific field comprises:
a first set of bits indicating set of time resource occurring periodically; and
a second set of bits indicating set of contiguous frequency resource blocks.

8. The method of claim 1, wherein:
the specific field comprises 4 bit information; and
the 4 bit information corresponds to least significant bits of the index value.

9. The method of claim 8,
wherein the specific bit in the second set of bits corresponds to most significant bit of the index value.

10. The method of claim 1,
wherein the terminal determines that type zero physical downlink control channel (PDCCH) common search space (CSS) set:
is present in the first cell in case that the index value is within the first range;
will be present in the first cell in case that the index value is equal to the first specific value; and
is not and will not be present in the first cell in case that the index value is neither within the first range nor equal to the first specific value.

11. A terminal in a wireless communication system, the terminal comprising:
a transceiver configured to transmit and receive a signal; and
a controller configured to control the transceiver to:
receive in a first cell a synchronization signal physical broadcast channel block (SSB), and
perform in the first cell a procedure for system information acquisition,
wherein the SSB comprises:
a primary synchronization signal;
a secondary synchronization signal; and
a transport block,
wherein the transport block comprises:
a first set of bits corresponding to master information block; and
a second set of bits appended to the first set of bits,
wherein an index value is determined based on:
a specific bit in the second set of bits; and
a specific field of the master information block,
wherein a first procedure is performed for system information acquisition in case that:
a frequency band of the first cell belongs to a first frequency region; and
the index value is equal to a first specific value,
wherein a second procedure is performed for system information acquisition in case that:
the frequency band of the first cell belongs to a first frequency region;
the index value is within a first range; and
a scheduling information of a second system information indicates that the second system information is not broadcasting,
wherein:
the first procedure is to request a first system information; and
the second procedure is to request the second system information, and
wherein:
the first system information comprises the scheduling information of the second system information; and
the second system information comprises one or more system information blocks.
